(19) United States
(12) Patent Application Publication
(10) Pub. No.: US 2012/0297182 A1
(43) Pub. Date: Nov. 22, 2012

(54) CIPHER AND ANNOTATION TECHNOLOGIES FOR DIGITAL CONTENT DEVICES

(76) Inventor: Sherisse Hawkins, Boulder, CO (US)

(21) Appl. No.: 13/474,492

(22) Filed: May 17, 2012

Related U.S. Application Data
(60) Provisional application No. 61/487,415, filed on May 18, 2011.

(51) Int. Cl. H04L 9/00; G06F 15/16

(52) U.S. Cl. 713/150

(57) ABSTRACT

Systems, methods, and/or devices are provided that include a variety of cipher tools and techniques that may be utilized with digital content on digital devices. Systems, methods, and/or devices are provided that include a variety of annotation tools and techniques that may be utilized with digital content on digital devices.

### CROSS-REFERENCE TO RELATED APPLICATIONS

This non-provisional patent application claims the benefit of U.S. Provisional Application Ser. No. 61/487,415, filed May 18, 2011, the disclosure of which is incorporated herein by reference in its entirety.

### FIELD OF THE DISCLOSURE

The present disclosure relates generally to electronic books and other electronic files. In particular, but not by way of limitation, the present disclosure relates to systems, methods, and apparatuses for encryption and decryption of messages, symbols, and images.

### SUMMARY OF THE DISCLOSURE

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

Some embodiments can be characterized as a method for generating an electronic file having an encrypted message therein. The method can include receiving an electronic file into a memory, the electronic file having a first text-based message. The method can also include receiving a second text-based message into the memory that is to be encrypted within the first text-based message. The method can further include generating, via an encryption module, a first proposed modification to the electronic file, wherein the first proposed modification encrypts the second text-based message in the first text-based message according to a first cipher selected from a plurality of ciphers.

Other embodiments of the disclosure can be characterized as a non-transitory, tangible computer readable storage medium encoded with processor readable instructions to perform a method for partially decrypting an encrypted message embedded in an electronic file. The method can include accessing an embedded message encrypted in an electronic file and stored in a memory. The method can also include accessing a tag in the electronic file, via a decryption assist module, where the tag identifies one of a plurality of ciphers used to encrypt the embedded message. The method can further include analyzing, via the decryption assist module, the electronic file using the identified cipher to partially decrypt the embedded message. The method additionally can include generating a partial decryption of the embedded message from the analyzing. Lastly, the method can include displaying the partially decrypted embedded message on a display device.

### BACKGROUND

Ciphers, codes, and encryptions have been used in different contexts for many years. Ciphers have sometimes been embedded into text such as books. Readers may look for clues within this text using powers of observation and deduction, for example. These methods may be limited especially in light of the growing use of digital content and digital devices.

Digital content viewed on electronic devices such as e-readers may also allow for a user to highlight and/or to provide comments regarding the text. However, a user may have problems sharing this information with other users. For example, some e-reader applications may only allow the sharing of user-generated content with other devices associated with a same system or a same format.

There is thus a need for tools and techniques that can overcome these and other problems.

### BRIEF DESCRIPTION OF THE DRAWINGS

A further understanding of the nature and advantages of particular embodiments may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIGS. 1A-1Y illustrate screen shots of an example of cipher tools and techniques in accordance with various embodiments.

FIGS. 2A-2F illustrate screen shots of another example of cipher tools and techniques in accordance with various embodiments.

FIGS. 3A-3D illustrate screen shots of another example of cipher tools and techniques in accordance with various embodiments.

FIGS. 4A-4F illustrate screen shots of an example of annotations tools and techniques in accordance with various embodiments.

FIG. 5 illustrates a schematic of a user device that may be utilized to implement cipher and/or annotation tools and techniques in accordance with various embodiments.

FIG. 6 illustrates a schematic of a system that may be utilized to implement cipher and/or annotation tools and techniques in accordance with various embodiments

FIG. 7 illustrates a flow chart for generating and delivering an electronic file.

FIG. 8 illustrates a block diagram of a system configured to encrypt a message in an electronic file.

FIG. 9 illustrates a method for encrypting a message within an electronic file.

FIG. 10 illustrates a block diagram of a system configured to decrypt a message in an electronic file.

FIG. 11 illustrates a flow chart of a method for decrypting an encrypted message.

FIGS. 12-16 illustrate exemplary user interfaces demonstrating an electronic file being partially and then fully decrypted by a user with the help of a decryption assist module.

### DETAILED DESCRIPTION

Embodiments provide methods, systems, and or devices that may provide digital content that can be tailored in such a way that embedded ciphers can be found through use of cipher solution application. Embodiments may provide tools and techniques that may be separate from the content itself. Some embodiments may uses a stand alone protocol for sharing data that is device agnostic. Some embodiments may be based on the assumption that users can solve ciphers embedded in the core content while the content stands alone. For example, a cipher may be embedded in a digital book about botany where the subject matter is completely unrelated to technology, puzzles or digital content. Some embodiments may have no requirement that the users are online and participating at the same time.

The types of ciphers may include, but are not limited to, the use of the following as clues to the solution: (1) textual patterns (i.e. first word of each chapter, last letter of each paragraph, some combination of clues in punctuation, format, or spacing); (2) palindromes; (3) anagrams; (4) mnemonics; (5) use of synonyms, homonyms, antonyms, intentional misspellings; (6) numerical patterns; and/or (6) nested patterns.

Embodiments may provide additional entertainment or educational value to digital content consumed using electronic devices including, but not limited to, computers, tablet computers, e-readers, cell phones, personal digital assistants, and/or display devices. By embedding ciphers in this content, the user can explore and interact with the original source material in a new way, a way that is optional and in addition to the primary purpose for consuming this content (i.e. reading a story). These ciphers can be created and solved using software tools created for this purpose. Some embodiments will utilize text-based content; however, other digital content may be used as a source, clue, or solution.

Some embodiments may provide a mechanism for individuals who may have rights to the same digital content to interact with each other through this media. For example, two users who have both purchased the digital version of the same book may, through the cipher solving tools and techniques, contact and connect with each other to swap information, clues, and/or solutions to ciphers that may allow them to unlock future ciphers, complete a cipher that they could not solve alone, and/or get hints on how to solve a cipher, for example. In some embodiments, tools and techniques provided may allow users to collect and/or trade information embedded in the content.

In some embodiments, solving the cipher may involve the user to touch certain portion of the text or illustrations in the content. Solving the cipher may involve the user having to touch or interact with the content in a specific order of actions Solving the cipher may involve the user to invoke electronic gestures on portions of the content. Solving the cipher may involve combinations of touch, gesture, analysis, capture of audio of video content via microphone and/or camera, for example. Solving the cipher may involve collaboration with other owners of the same content downloaded to their individual devices.

Ciphers may be within books, across pages, chapters, sections, text and/or illustrations in some embodiments. Ciphers may be between books, series of books, and/or other digital content by same publisher, author, producer etc.

In some embodiments, users may swap for random items before knowing how they will use those items or clues (application is not readily apparent at the time of swap). Users may get credit for solving ciphers that may be used to purchase additional items (new content, hints, ability to be featured in an awards cipher solving Hall of Fame). User may gets an extra bonus cipher if they do not use any hints to solve the “core ciphers”

In some embodiments, clues to help solve a cipher may be found in different locations. For example, some clues may be provided at a website. Some embodiments may be configured to allow a user to leave clues for the user to remember what the user figured out or parts of a cipher. The user may save their place so that they can remember what they have figured out mid-cipher and including recording notes on their progress or hypothesis on how to solve the cipher.

Some embodiments may track a users steps. In some cases, a user may turn a marker function to see where the user went. Some embodiments may provide information regarding how long it took a user to solve one or more parts of a cipher. Official time keeping of how long someone has worked on a cipher (perhaps prize for fastest official solution) may be provided.

Some embodiments may include different genres of ciphers. A user may pick a genre of ciphers in the content. Merely by way of example, genres may include numerous different genres including, but not limited to, Greek mythology, geography, and/or state capitals. Some embodiments may allow a user to solve the solutions with different trivia.

Some embodiments may allow a user to post stuff and hints and other items to a bulletin board that other users that have the content can see. In some cases, a user could provide hints and credits to other users, such as user's friends. Some embodiments may allow a user to buy hints (using real money, for example) that only works on the user's account—these purchased hints may be keyed to only this user's version of the content.

Some embodiments may include a specific virtual item when a solution to a cipher is found. Some embodiments may allow the specific virtual item to be traded in for a real item for the virtual item. For example, if the solution is something like “chocolate bar”, a user could trade in proof of the solution to receive a real candy bar at a store. In some embodiments, this may utilize snap tags. In some embodiments, users may receive credits for solving ciphers. If enough users solve the cipher, they could donate their credits to a needy cause in some cases. Users may get something special for donating their credits and helping others (i.e. “good guy points”) that can be used for an entire other category of stuff in some embodiments.

Some embodiments may involve the use of gestures with an object. For example, a number of finger taps on an a user device may equal some action that may be part of a cipher, such as the number of times a hammer hits a nail. Gestures on a user device may include tilting the device in some cases. For example, this action could represent the rolling of a ball around the letters on a page presented on a user device then fall into the word “hole”. In some embodiments, the order in which items are utilized may be important. For example, if a user picks up something that they don't need or use, the user may need to return it to its proper place before completing a cipher or other problem. Some items may not work until the right time have arrived where time can be defined as number of minutes spent in the game, changing the time within the game to be a certain point (i.e. move the hands of a clock to make the time in the game be midnight) or only after certain events have happened in a certain order is it the right time for a certain clue to be found or solved, for example.

Some embodiments may allow a user to record their voice, video, and/or picture in certain places. In some cases, other users may be able see this if the user solves a cipher and/or wins and get to the end of the content. In some embodiments, only winners may be able to see and contribute to this winners circle content. Some embodiments may allow musical content to be embedded and allow for feedback. For example, a musician may embed their music in content and provide a song for download to those who provide feedback.

Some embodiments include a cipher solving tool application that is content agnostic and/or device agnostic. In some cases, collaboration with others who have the same tool may be involved. Some embodiments may require that each user to have a legitimate copy of the source content. For example, in some cases, a second generation of the content may disable the embedded ciphers. This aspect may provide a means to protect the rights of content creators.

Embodiments may utilize a variety of tools and techniques for the creation and/or solving of ciphers related to different forms of digital content. Some embodiments may involve a variety of nested ciphers. In some cases, nested ciphers may be between pieces of related and/or unrelated content. Some embodiments may handle sharing of cipher clues in a digital content device agnostic way.

Some embodiments may provide cipher modules that may enhance the cipher cracking system any single user might need. Some cipher modules may provide hints for some subset of ciphers. Some cipher modules may reveal deeper ciphers, and/or update cipher cracking technologies.

Some embodiments may provide cipher tools and techniques that may be utilized for a variety of cipher levels. For example, some cipher tools and techniques may be able to work with cipher associated with digital content directed at preschoolers to adults. Some embodiments may utilize cipher tools and techniques that are utilized for specific cipher levels, such as preschool level cipher or adult level ciphers

Merely by way of example, one embodiment may involve different cipher tools and techniques related to digital content in the form of a children's story. For example, a children's story might be that each child has a collection of marbles including only one primary color (i.e. red). By trading their marbles with other children who own the same digital content, it may be possible for each child to acquire a set of marbles that represent all the primary colors (red, blue, yellow), and the reward for completing this quest is the ability to mix the pigments to create all the colors of a rainbow. Once they have successfully mixed the primary colors together to make 3 secondary colors the cipher is nearly complete. The creation and display of a rainbow with the right order of color bands is a final solution to this elementary grade level cipher. The rainbow may animate, emit a sound or lead to a pot of gold containing a coupon toward a future book, for example. Embodiments may utilize different digital content with different cipher tools and techniques.

Digital content targeted at adult consumers might follow the same general process. For example, embodiments may include aspects including, but not limited to, discovery, exchanging elements of the story with other content owners, manipulation of data, and/or final reveal of solution where something interesting may happens. Such embodiments may be more elaborate and complex and may involve the aid of the electronic cipher solving tools versus a user's application of static knowledge such as color types and combinations.

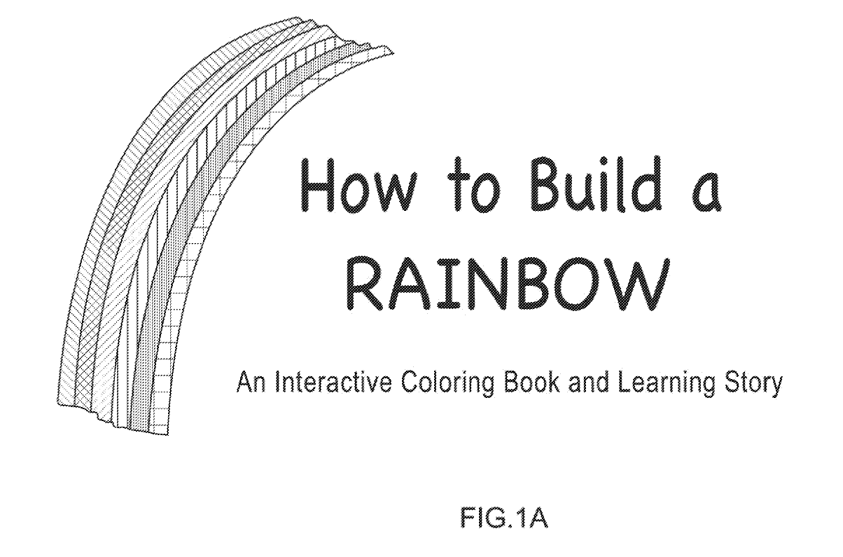

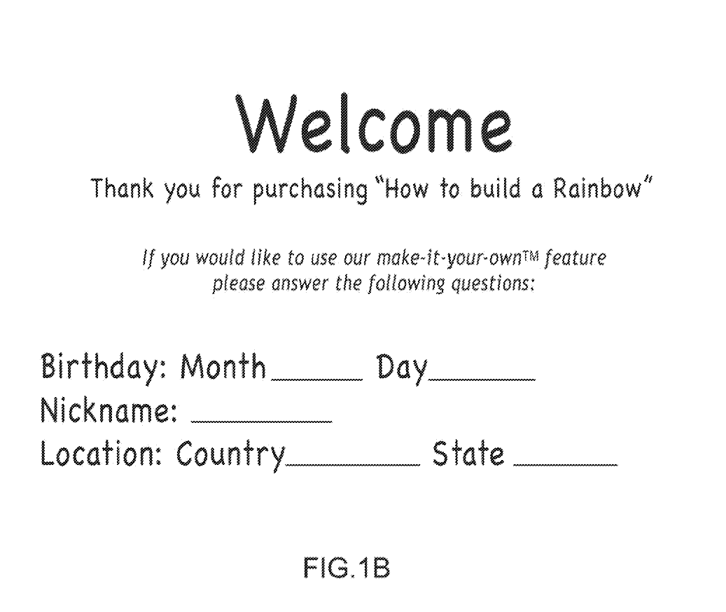

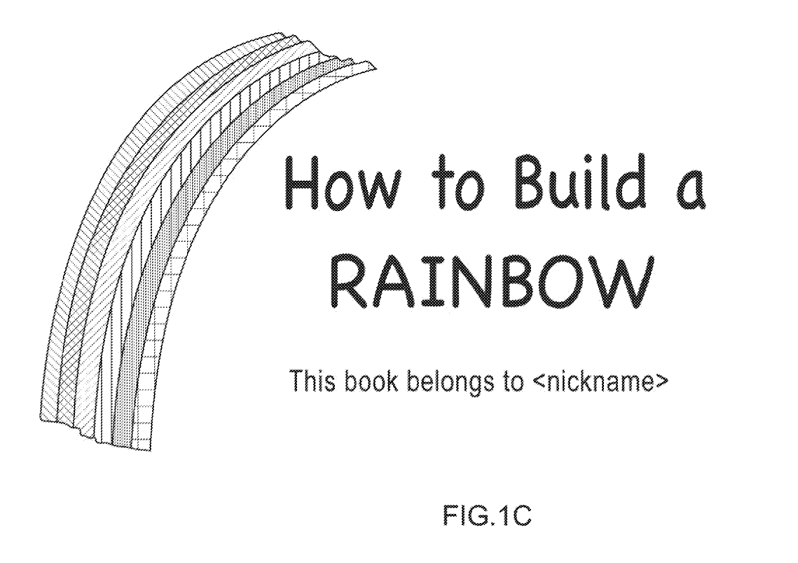

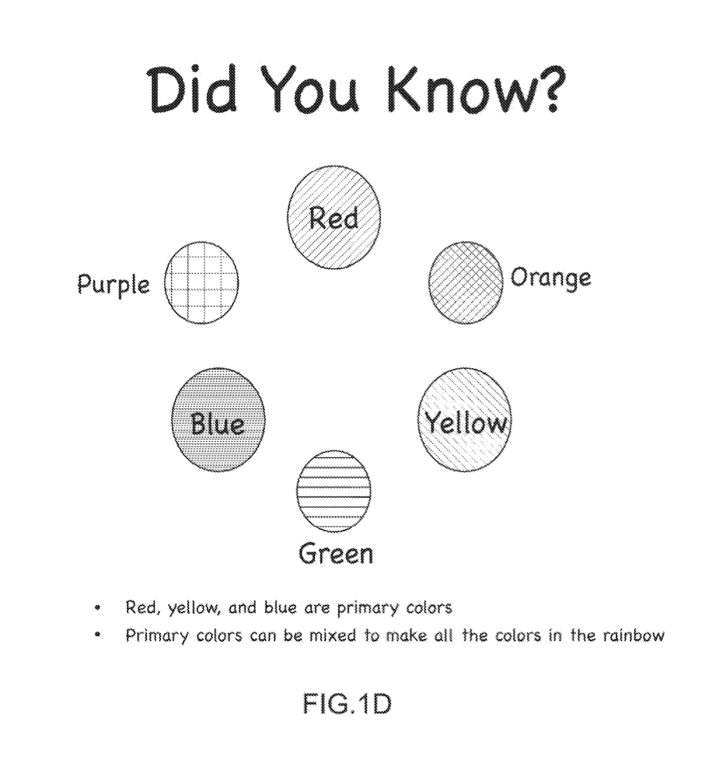

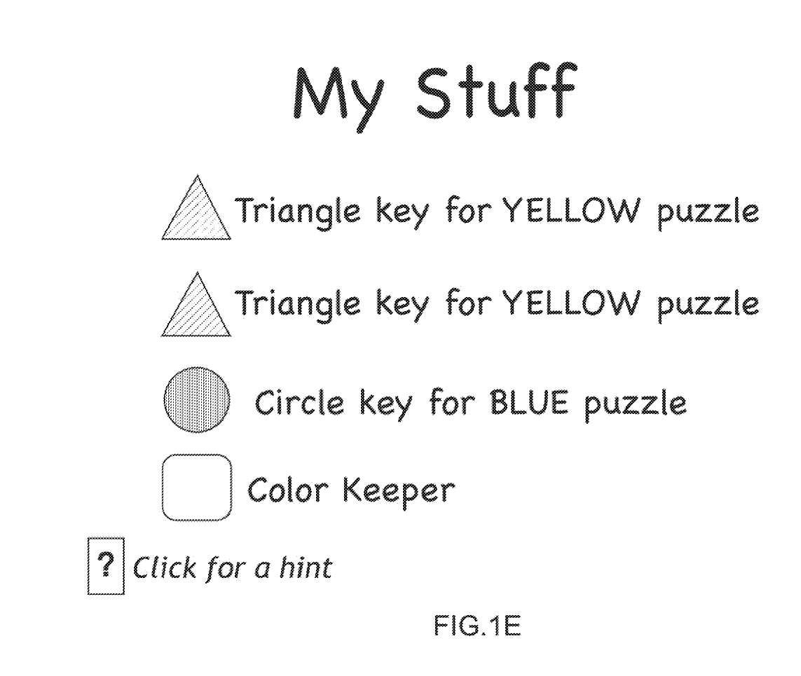

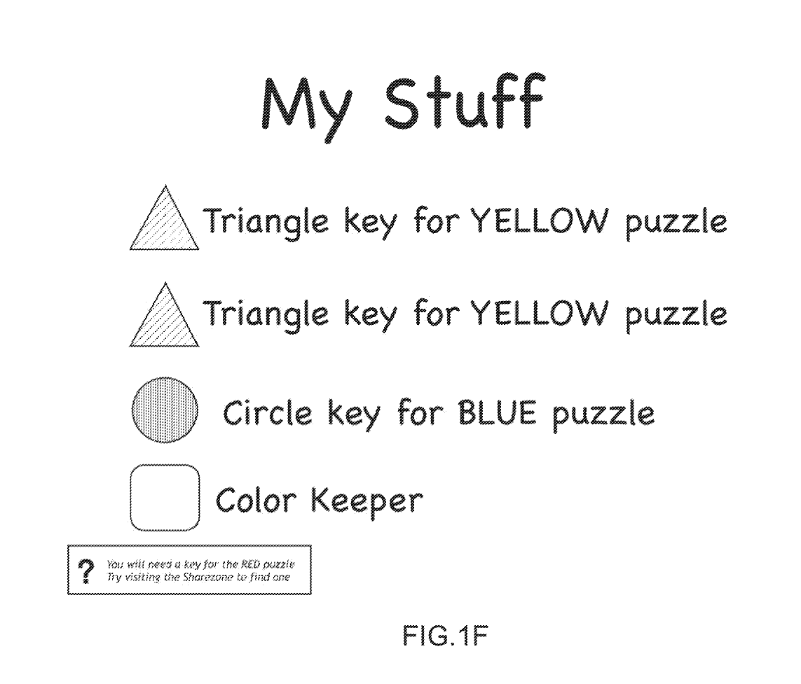

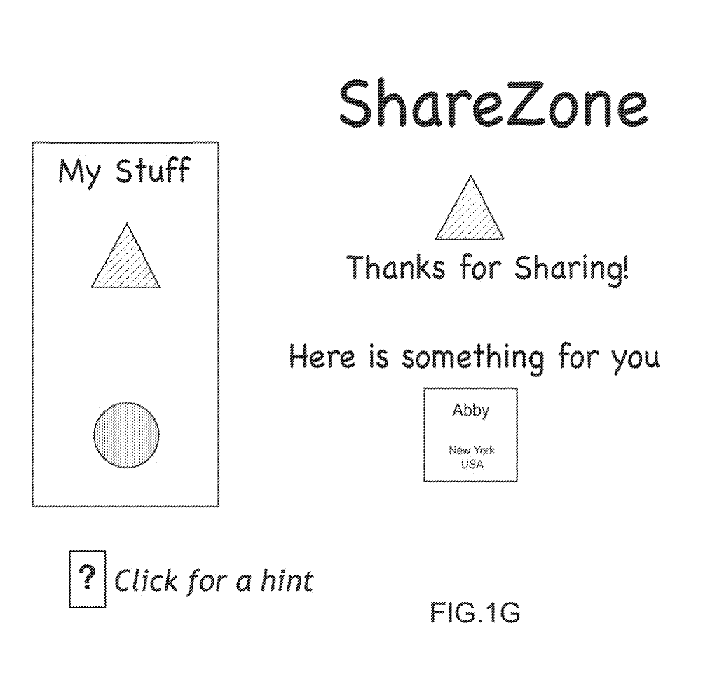

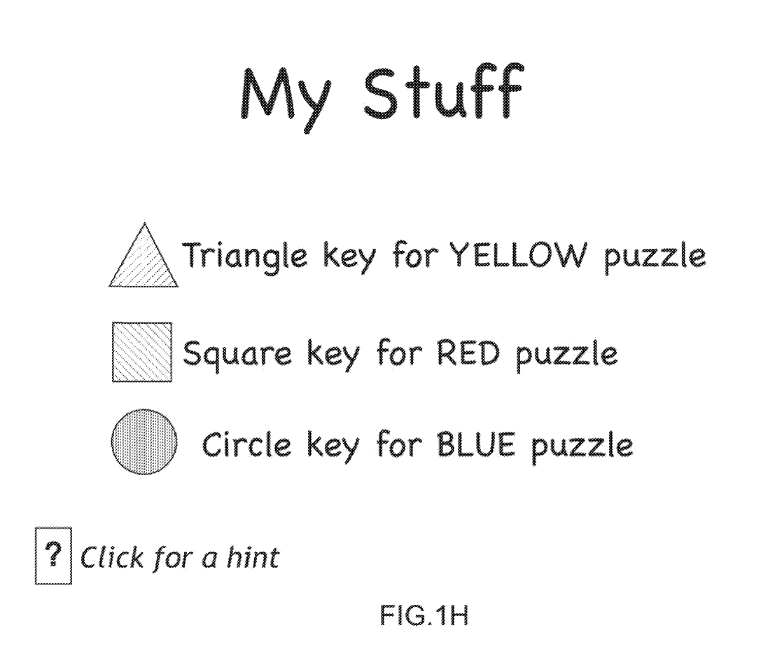

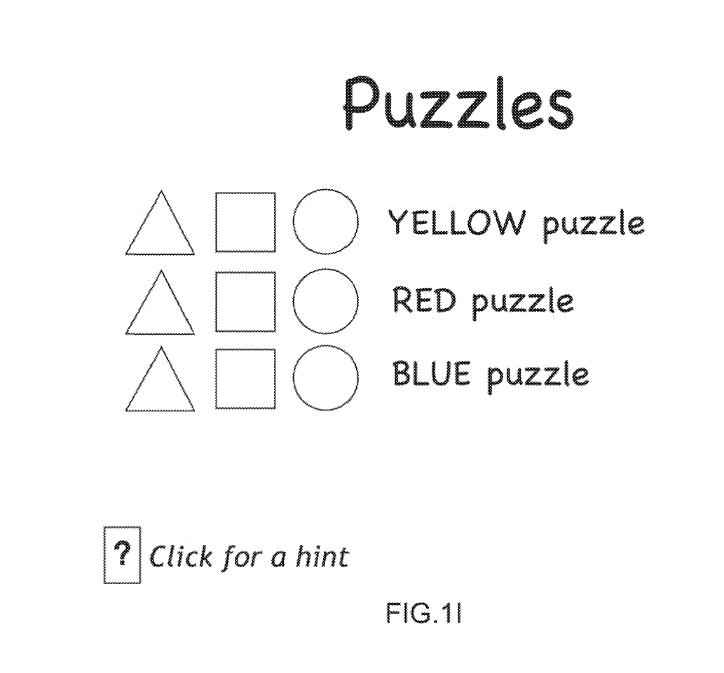

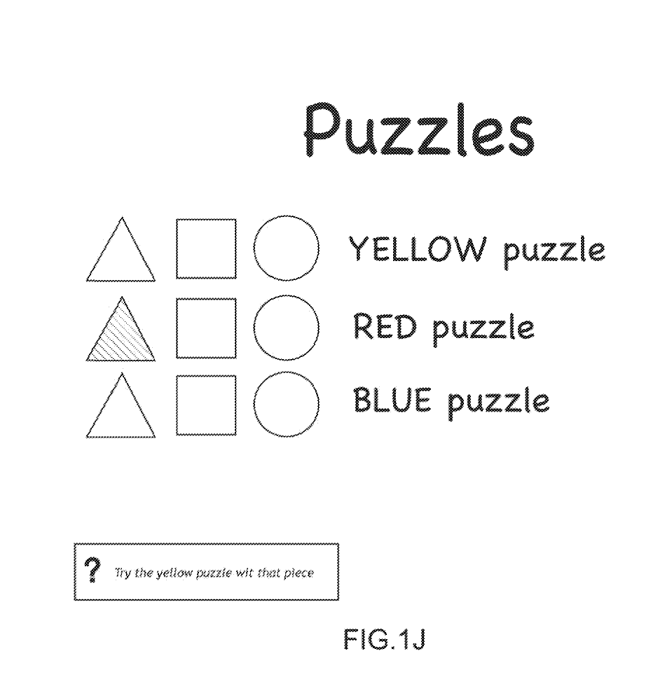

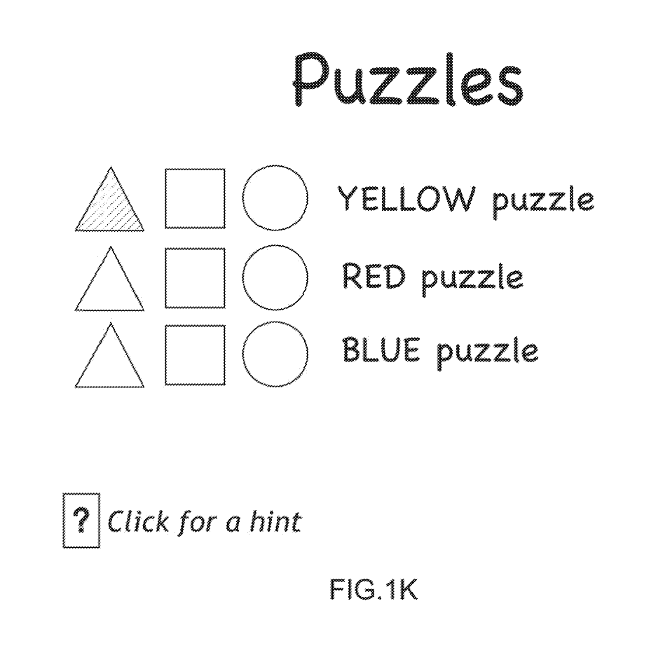

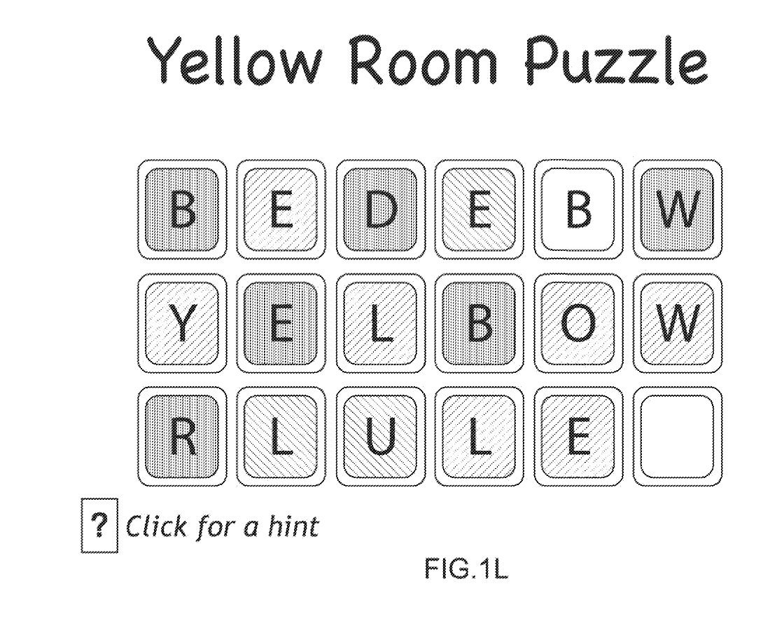

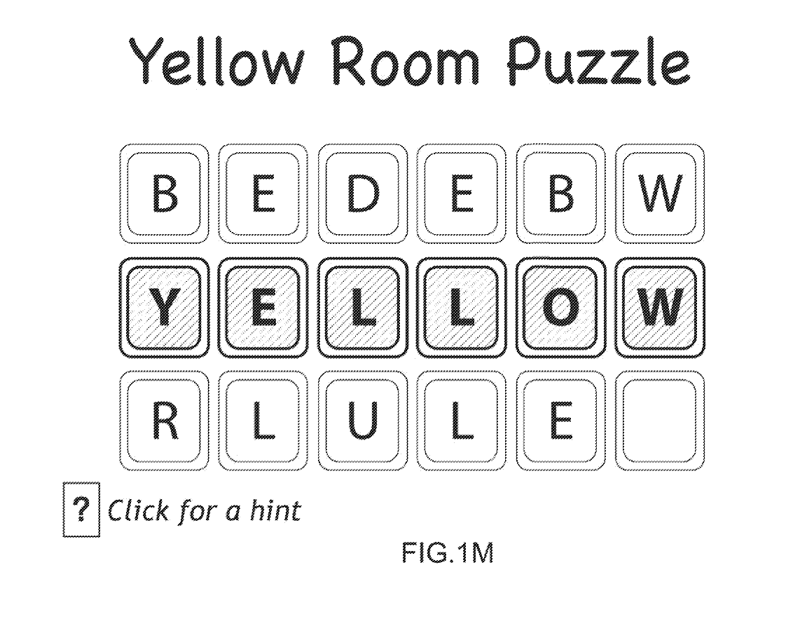

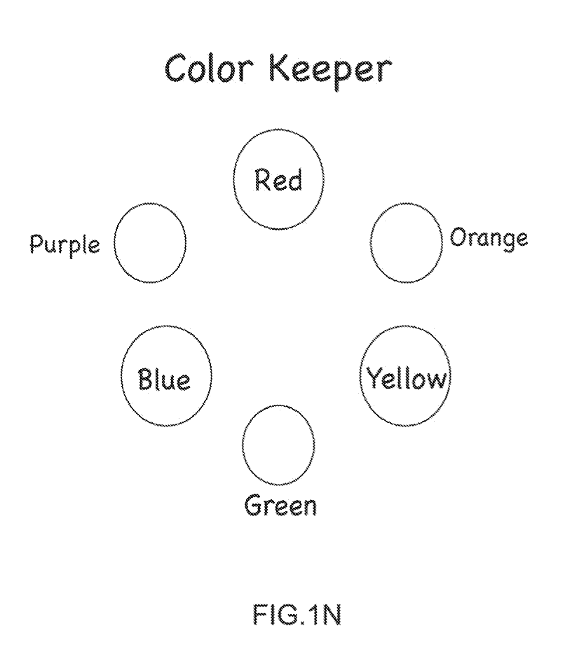

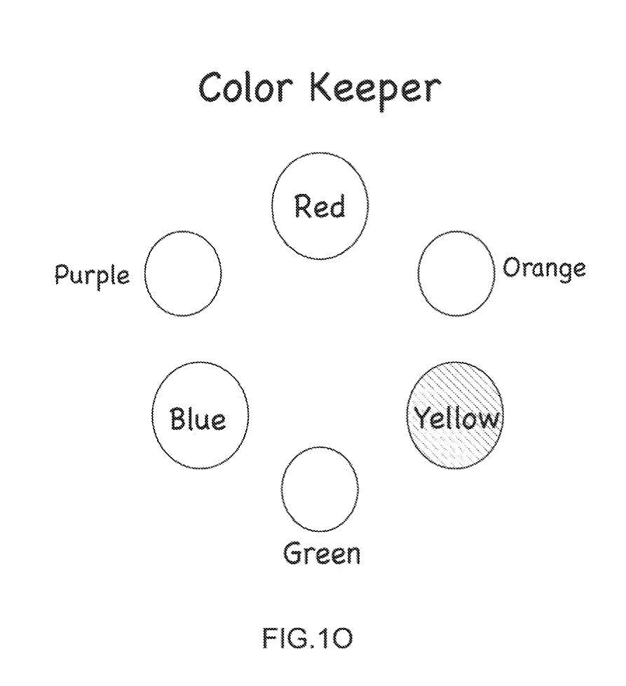

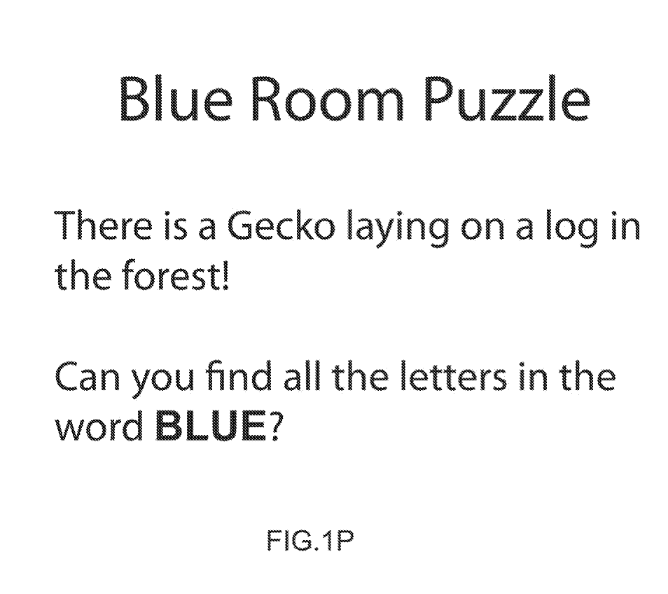

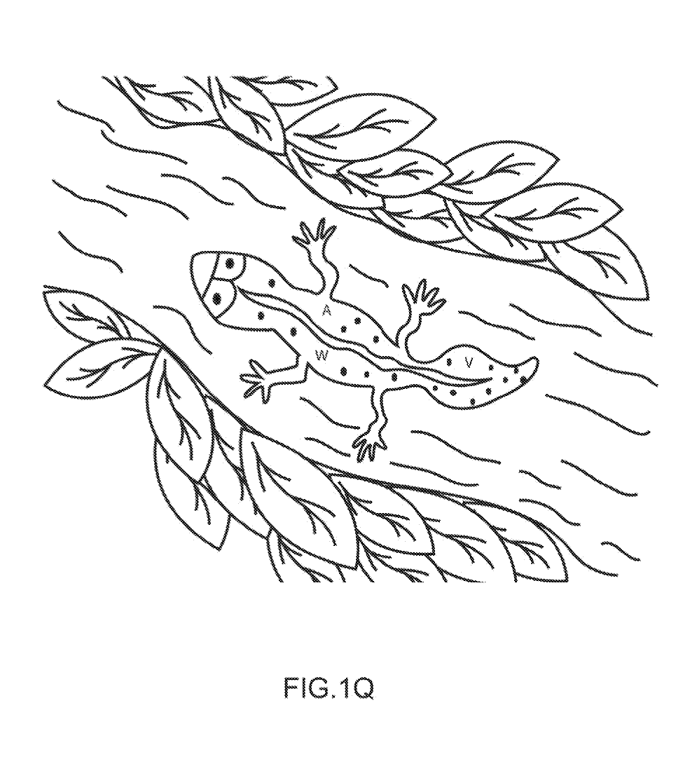

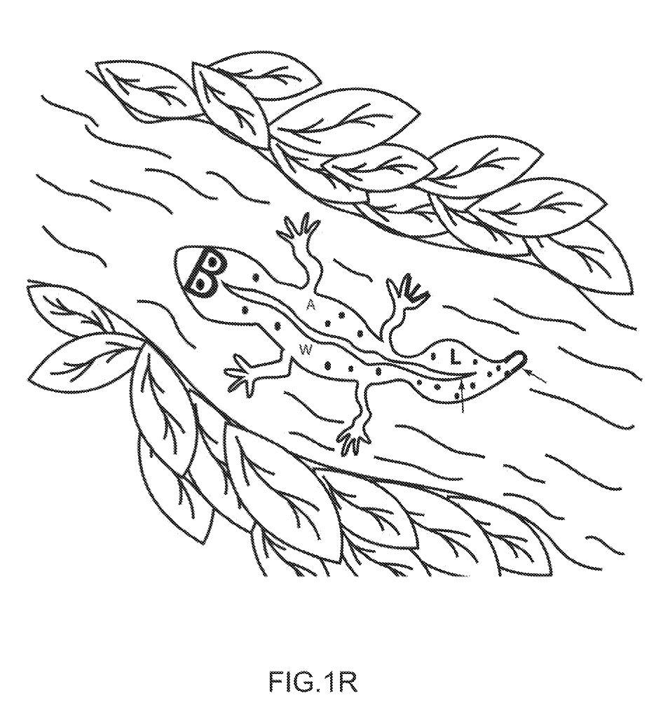

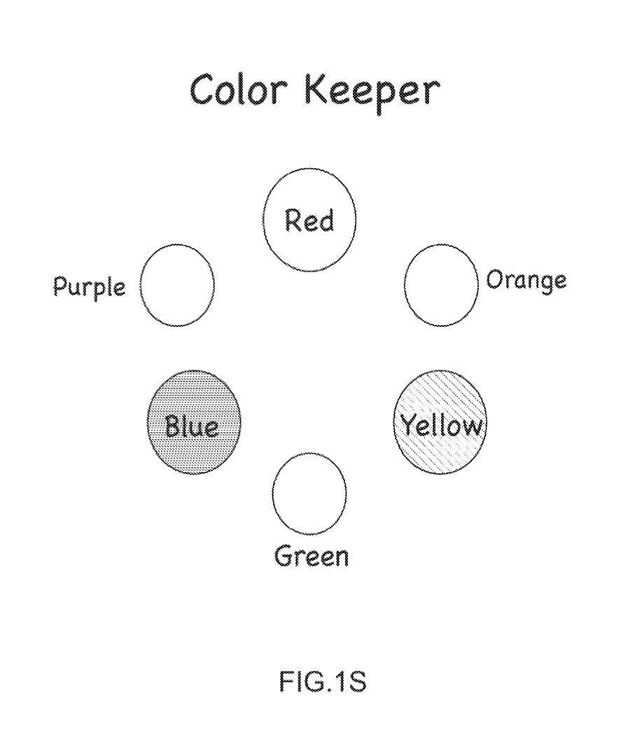

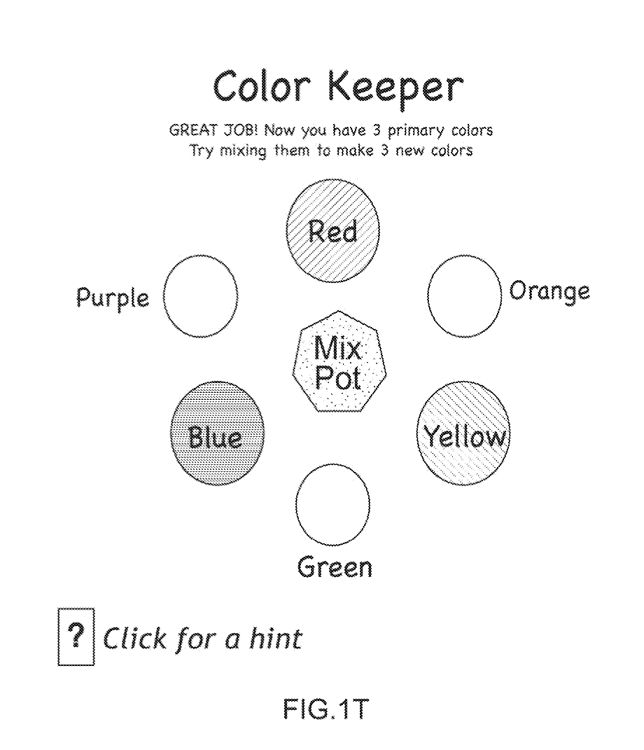

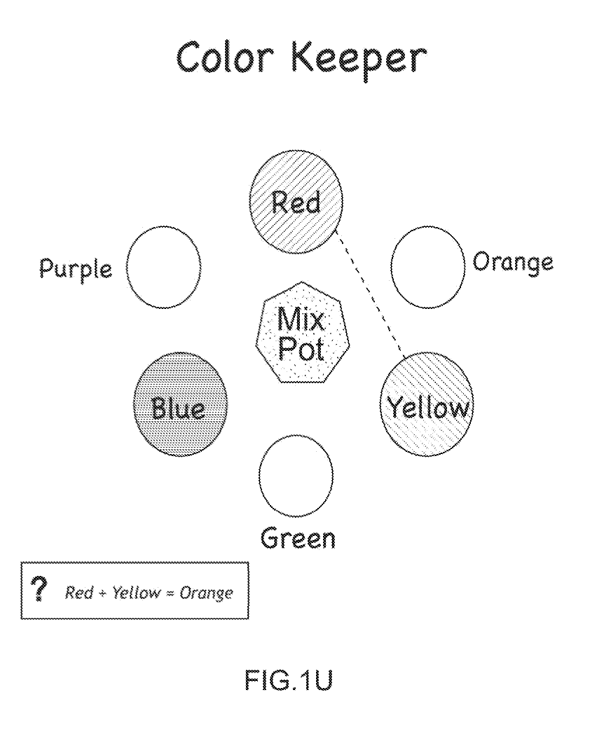

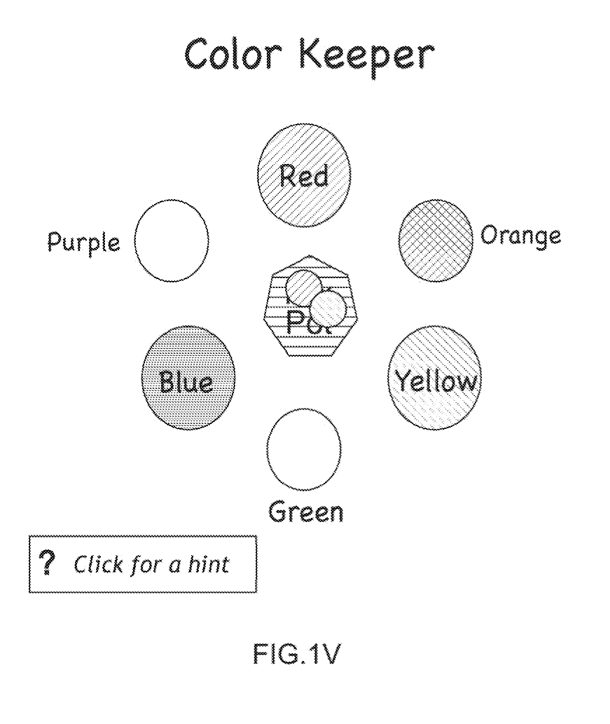

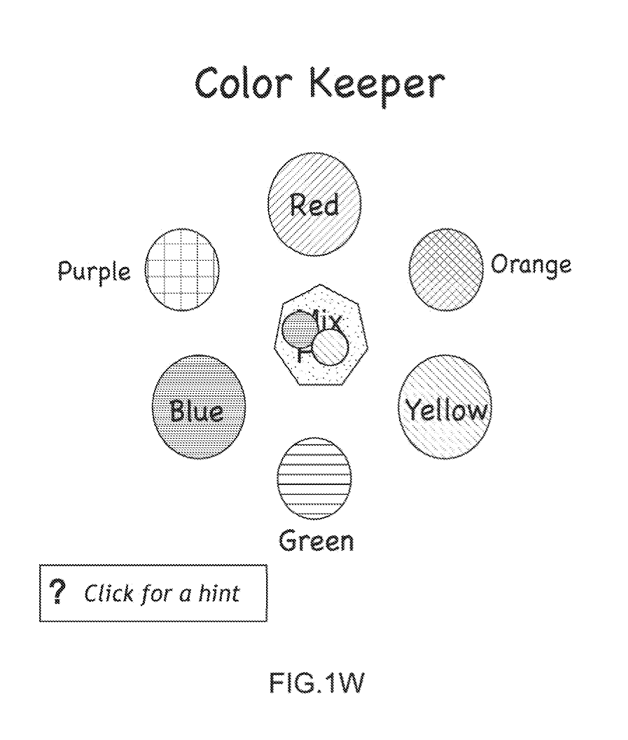

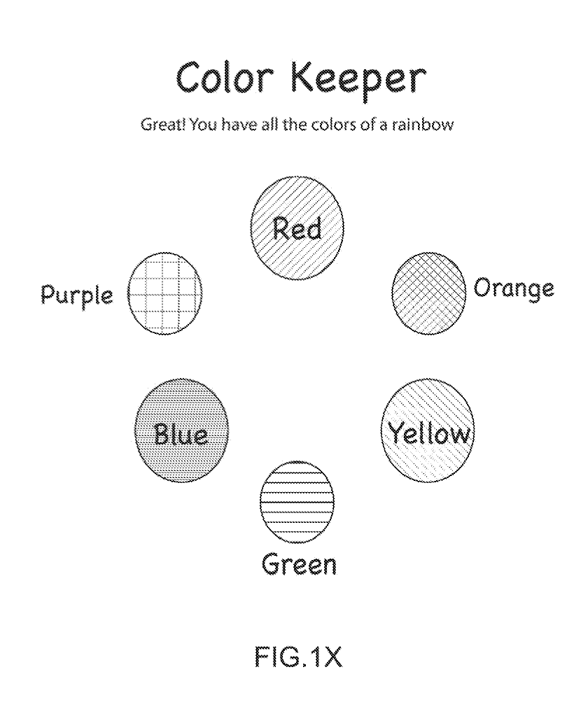

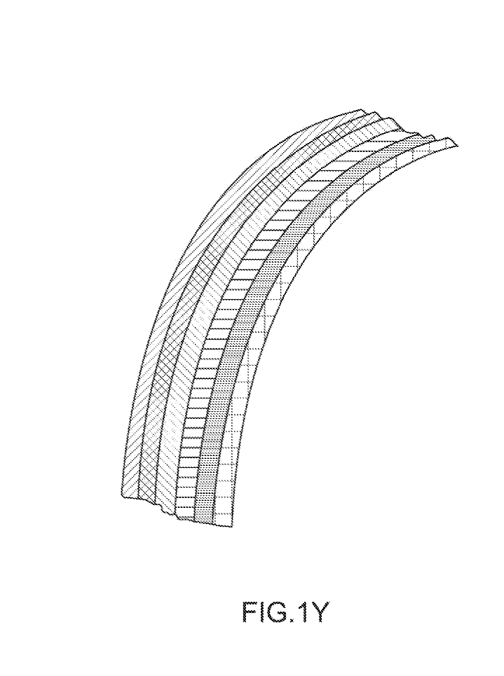

Merely by way of example, FIGS. 1A-1Y show a series of screen shots that may be viewed on a digital content viewer similar to the above cipher application related to digital content related to a child's story. Other embodiments may include other cipher content that may be related to the digital content that may be viewed. FIG. 1A shows an introduction that may be presented with an embodiment is launched. FIG. 1B illustrates an example of a screen shot providing a welcome and opt-in page for parents and/or users as the mechanism to personalize the experience. In some embodiments, if a user may choose not to do this the first time the embodiment is launched, the user may come back to this page later by visiting the applications settings. This information may be stored locally. This information may also be stored and associated with items places in the sharezone (i.e. the shared red key in FIG. 1G from Abby in NYC). FIG. 1C provides splash screen after the personalization info has been saved. In this example, a nickname may be filled in with the opt-in page data. FIG. 1D provides a screen shot of a basic digital content page in accordance with various embodiments. In some embodiments, no specific actions or input from user may be involved here although the color circles might wiggle or giggle when you touch them or say the color they are.

FIG. 1E provides a screen shot of a person page, which may be referred to as a my stuff page. This screen may provide a common experience between all the applications. The items a user has, trades, buys, wins, and/or otherwise acquires may be shown anytime they touch the my stuff icon. Alternatively, the my stuff list may be invoked and unhidden at anytime by touching a tab that says “my stuff” that peeks out from the border edge of each screen. FIG. 1F provides an example of what may happens when the user touches the hint (?) icon. A hint may appear on what action the user can do next. FIG. 1G provides a screen shot of a mock up of the sharezone (no graphics) when the user may put an object into the share zone (in this case a surplus yellow triangle) object dissolves or animates away (or, if the meta puzzle of getting objects from each state in the country is active the object flies onto the state that the user registered from). The item that the user may need (determined by the program in the novice level, for example) or an item that the user picks (user may need to understand what they need through deduction in the more advanced levels) can be placed in their “my stuff” area for safekeeping. Objects obtained from other users (via sharezone, for example) can be tagged with the name and location from their original owner (if they have opted to share this information, for example).

FIG. 1H provides a screen shot of updated “my stuff” showing 2 original keys (yellow and blue) plus the new red key acquired in the sharing process illustrated in FIG. 1G. FIG. 1I provides a screen shot of an example of puzzle launch page. The user may put the right color key into the correct shape next to the puzzle they want to visit. FIG. 1J provides a screen shot of user trying the incorrect key and invoking a hint for what to try next. FIG. 1K illustrates a screen shot of usage of the correct key to launch the yellow puzzle (yellow triangle key placed in triangle keyhole next to yellow puzzle) Happy animation may happen as a reward for getting this right.

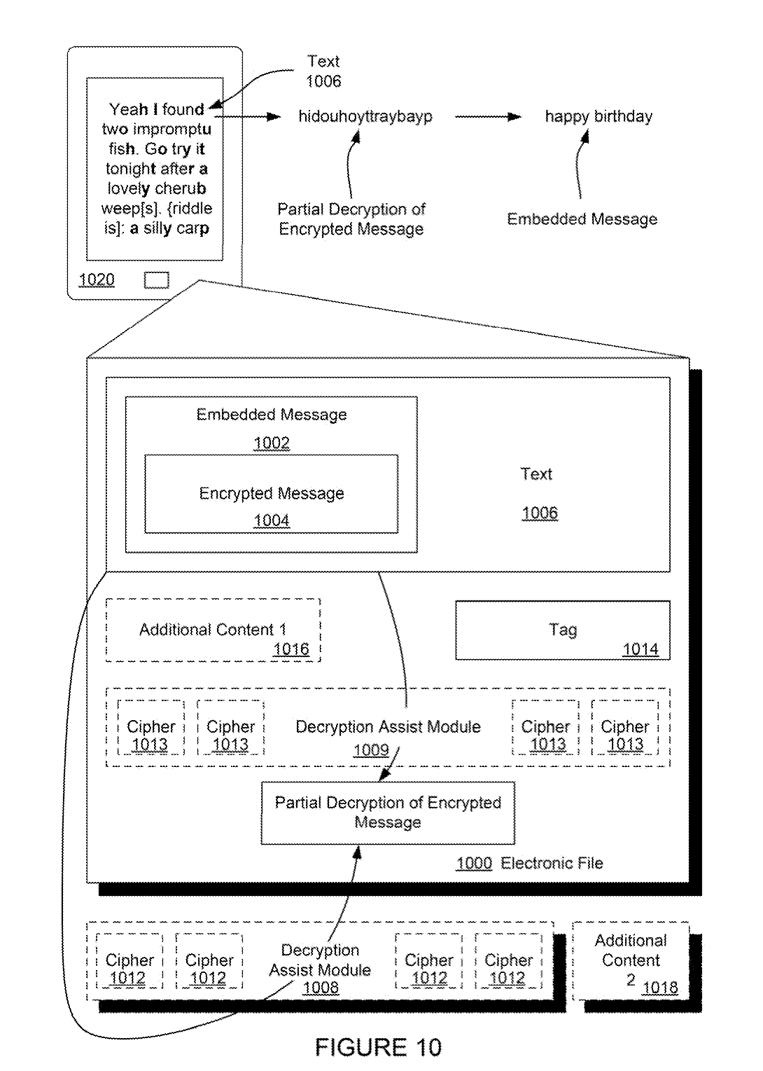

FIG. 1L provides a screen shot of an example of a color puzzle. The user may spin blocks vertically in each column until the letters spelling yellow appear in the correct order. FIG. 1M provides a screen show of the color puzzle reflecting what the correct solution of the yellow puzzle may look like. Happy animation may happen as reward for getting this right. In some embodiments, animated delivery of yellow color into their color keeper may be provided as shown in FIG. 10. A simpler version of this same puzzle may be made available as an option in the game for younger audiences. In this simple version, the word yellow is already spelled correctly but each letter is on a different color block. The child may need to tap the blocks until all of them are yellow.

FIG. 1N provides a screen shot of a color keeper that may be accessed by touching the color keeper icon in “my stuff”. FIG. 10 illustrates screen shot of the color keeper with the yellow circle filled in as a result of the user solving the yellow puzzle on FIG. 1M.

FIG. 1P illustrates a screen shot of blue puzzle instructions that may be accessed via same mechanism as shown in FIG. 1J. FIG. 1Q shows a screen shot of a blue puzzle and also example of a coloring book page that the user can color in once they have created colors of the rainbow. User may be tasked with finding all the letters in the word blue that are hidden in this image. FIG. 1R shows a screen shot of a solution to this puzzle. Letters may do a happy animation when the user touches them to solve the puzzle. As a reward for solving this puzzle, the color blue may be added to the users color keeper. In some embodiments, animate delivery of blue color into their color keeper may also be provided.

FIG. 1S shows a screen shot of color keeper now that two puzzles (blue and yellow) have been solved. FIG. 1T provides a screen shot of color keeper once all 3 color puzzles have been solved. In this example, a red puzzle is assumed and not shown explicitly in this deck. Once all primary colors have been earned, a congratulations note may appear with the recommendation to use the mix pot to make new colors. FIG. 1U shows a screen shot of an example of hint if user does not understand how to use the mix pot to create a new color. This application may recommend mixing red and yellow to create orange. Animation can be used to show the user how to implement this hint. FIG. 1V shows a screen shot of mixing yellow and red to make orange. A user may drag the colors into the mix pot. Then the mix pot may animate swirling the colors together to make the new color (orange). FIG. 1W provides a screen shot of mixing blue and yellow in the mix pot to create green. FIG. 1X provides screen shot of the color keeper with all colors accounted for through solutions to puzzles and correct use of mixing pigments in the mix pot. Happy animation and words of encouragement may be provided when the user finally has all the colors they need for their rainbow. FIG. 1Y shows a screen shot of completed rainbow. User has taken colors from color keeper to fill in black and white coloring book representation of the rainbow. The user may put the colors in the correct order for this puzzle to be successfully solved.

User can save their rainbow, user can go back through book and color black and white coloring book pages with the colors they now have in their color keeper. User can also use the colors to make their own original creations in the “doodle page” section of the book.

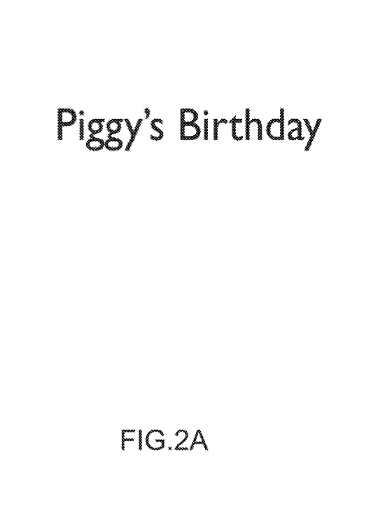

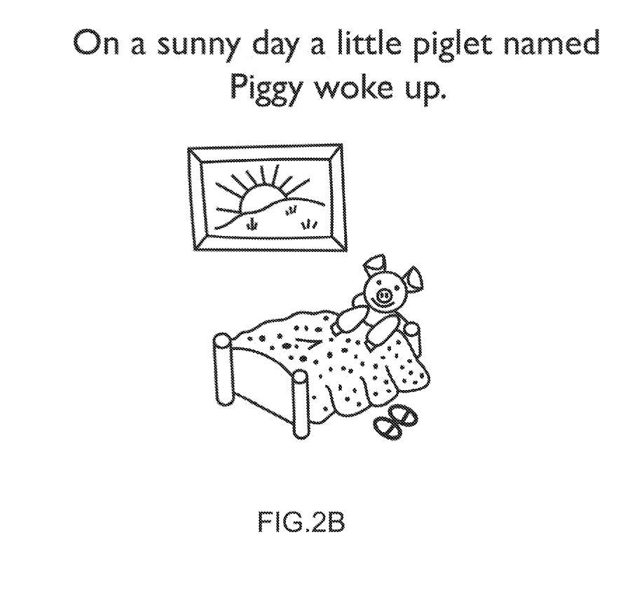

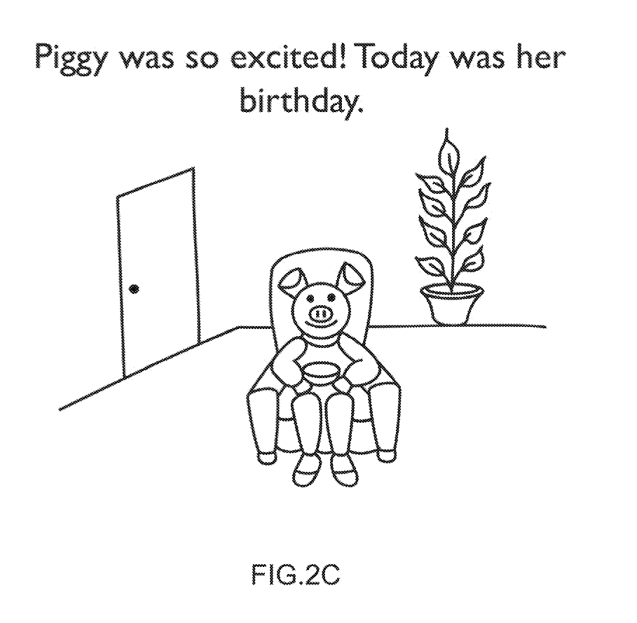

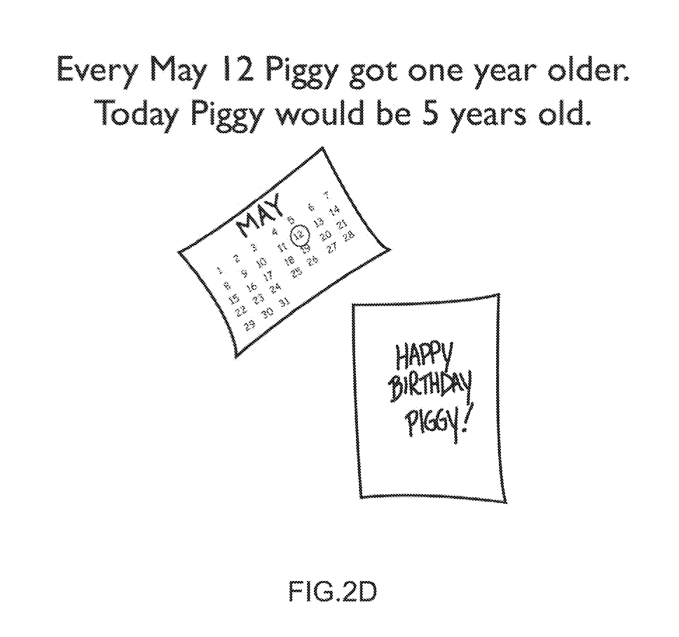

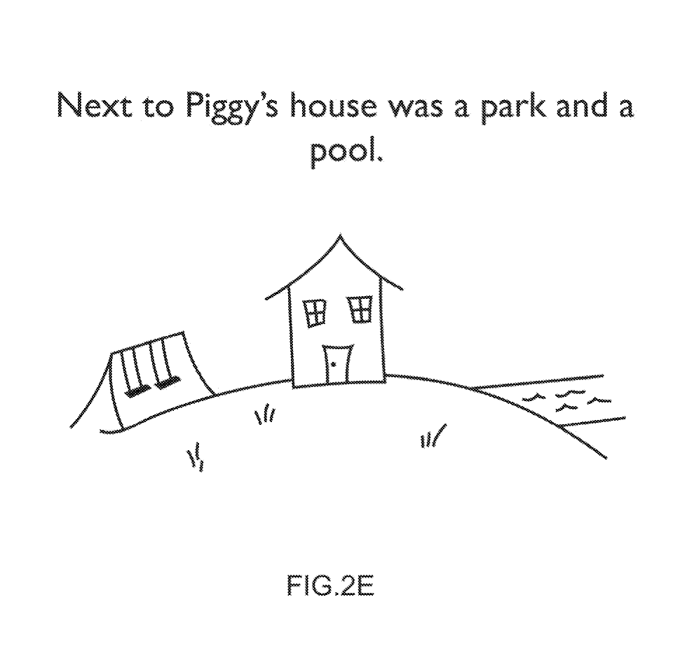

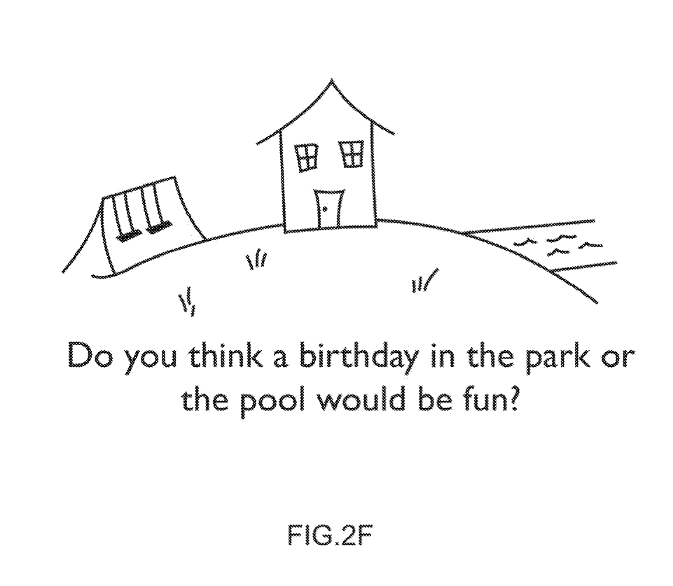

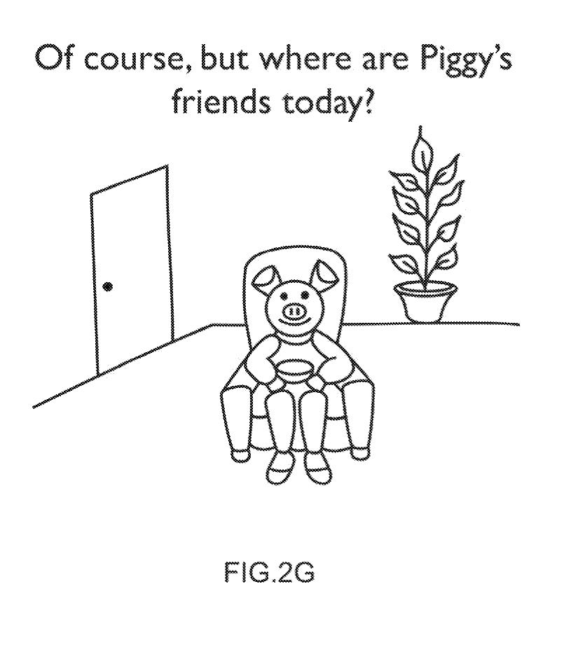

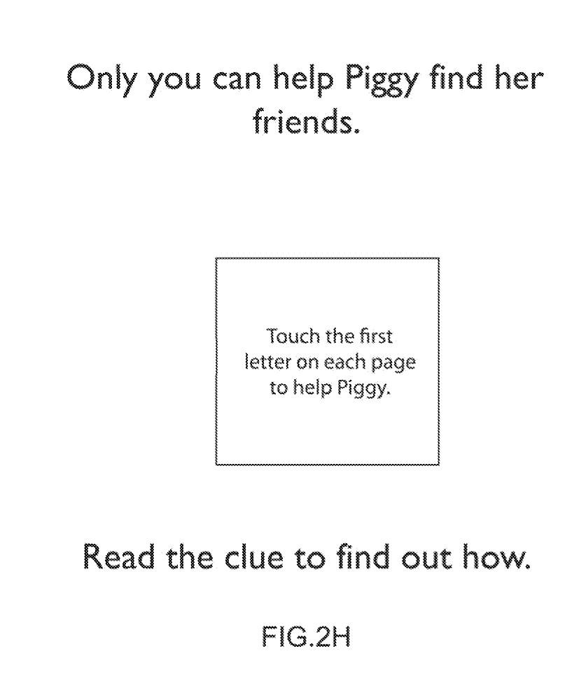

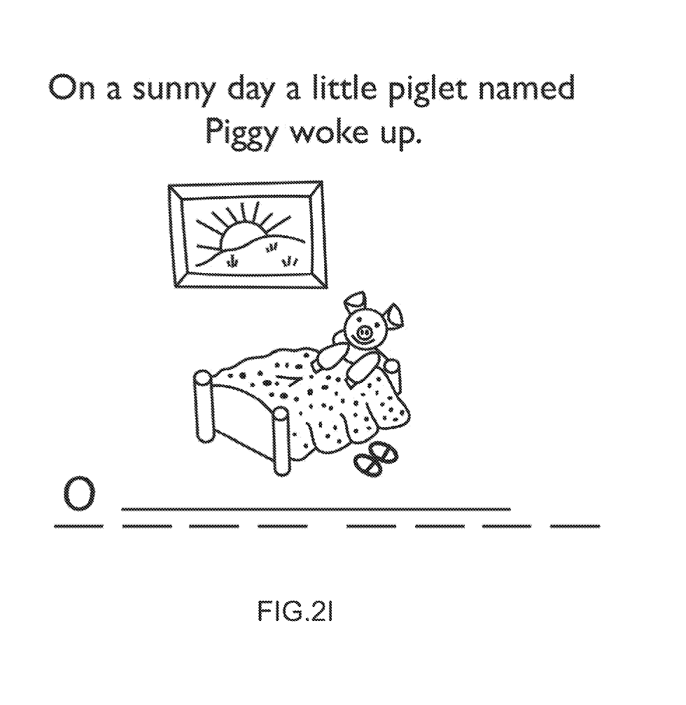

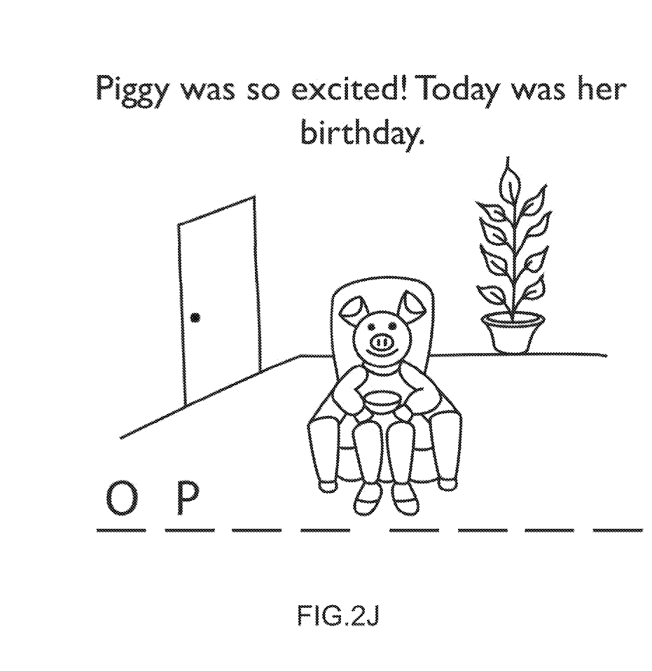

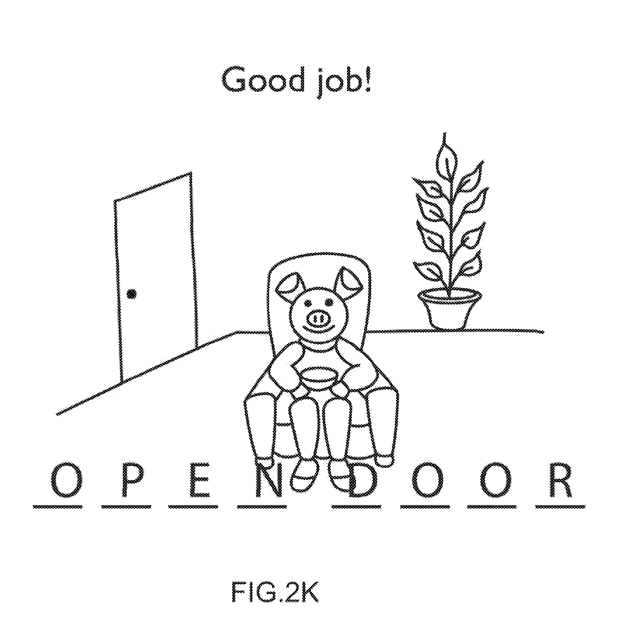

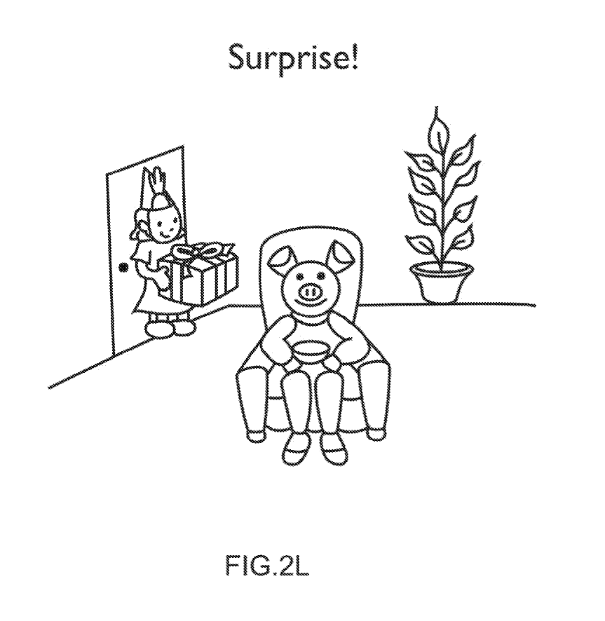

FIGS. 2 A-2L show other example of cipher tools and techniques for digital content in accordance with various embodiments. FIG. 2A illustrates a screen shot illustrating a title screen for a book. FIG. 2B illustrates a screen shot showing the first page of the book as the person reads it through for the first time. If they hit the first letter “O” at this stage, nothing may happen because they had not opened the clue yet (see FIG. 2H) which comes later in the story. FIG. 2C illustrates a screen shot that may just show the page that, in the future, the user may be able to touch the first letter “P” and have it added to the cipher solution (see FIG. 2J); in other words, FIG. 2B is to 21 as FIG. 2C is to 2J. FIG. 2D illustrates a screen shot showing a page from the book that is customizable. The month and date of the child's birthday may used (i.e. Piggy has the same birthday). It may be possible to also use the child's age here. FIGS. 2E and 2F illustrate screen shots showing the possibility for an interactive question to the reader. The reader can touch the park (swingset) or (pool) to “vote” on which birthday venue is the most fun. FIG. 2G illustrates a screen shot providing a dormant version of FIG. 2L. Touching the door this early in the story does nothing; however a) getting the clue by touching the box in FIG. 2H b) solving the cipher by touching the first letter on each page and c) finally tapping the door may allow all the criteria to be met so the door will open. FIG. 2H illustrates a screen shot showing a clue. FIGS. 21 and 2J illustrate screen shots showing that touching the first letter of the text starts to solve the cipher and the “hangman” solution begins to appear. FIG. 2K illustrates a screen shot showing cipher solution completed and the message is revealed to “open door” so the user has to go back and find a door in the story/picture and touch it to open.

FIG. 2L illustrates a screen shot showing “reward” for solving the cipher correctly. A guest arrives with a present for Piggy.

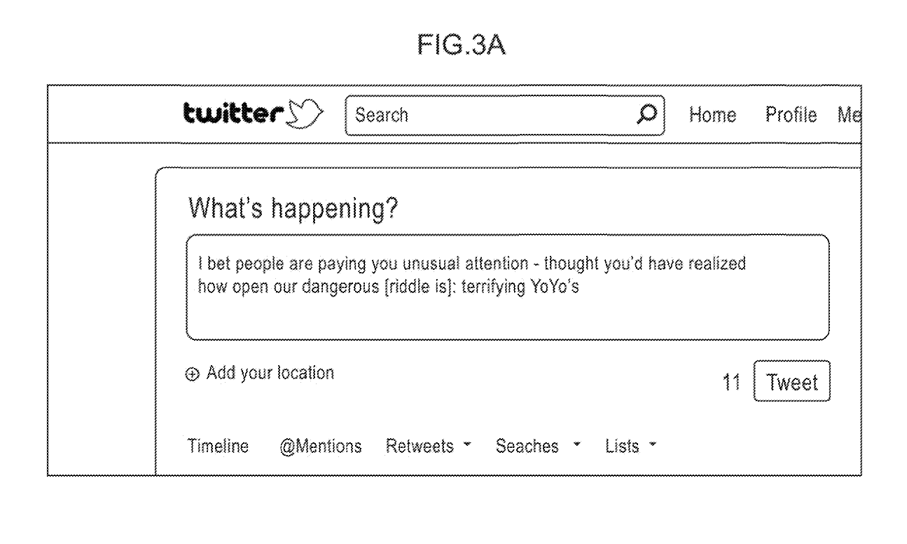

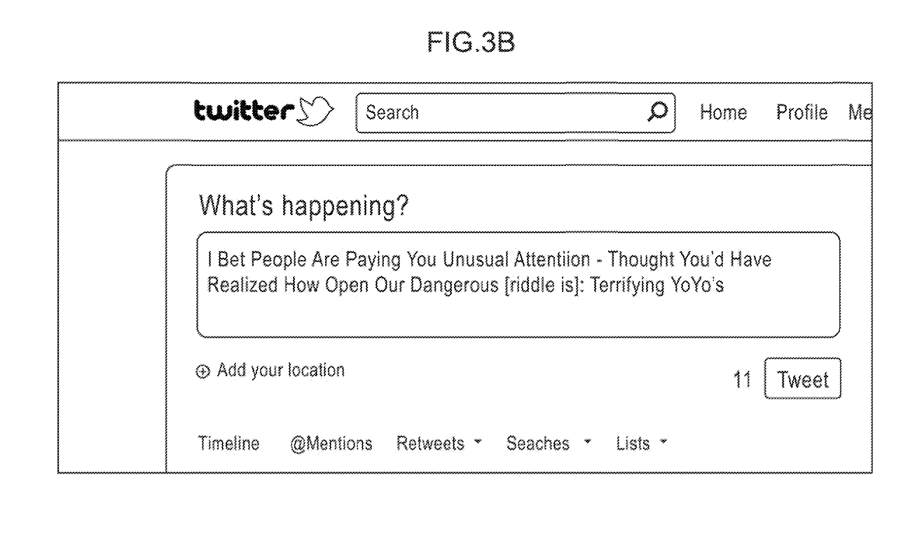

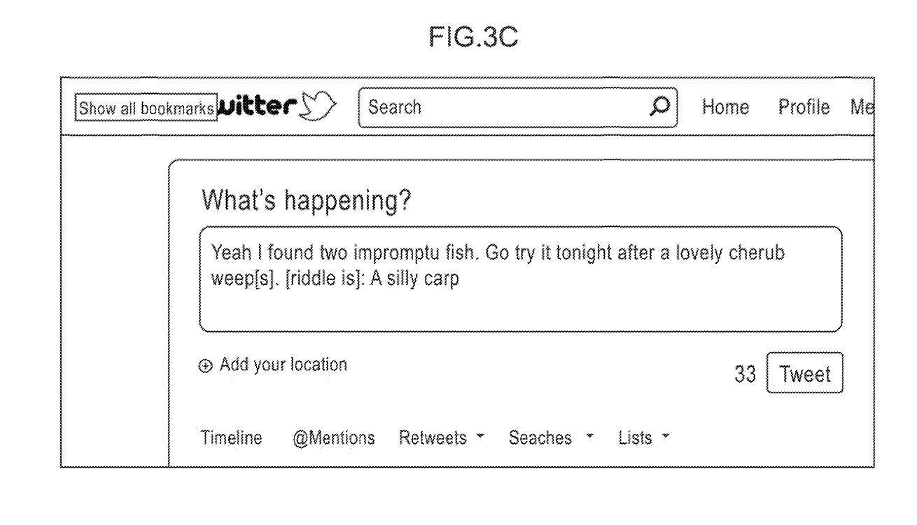

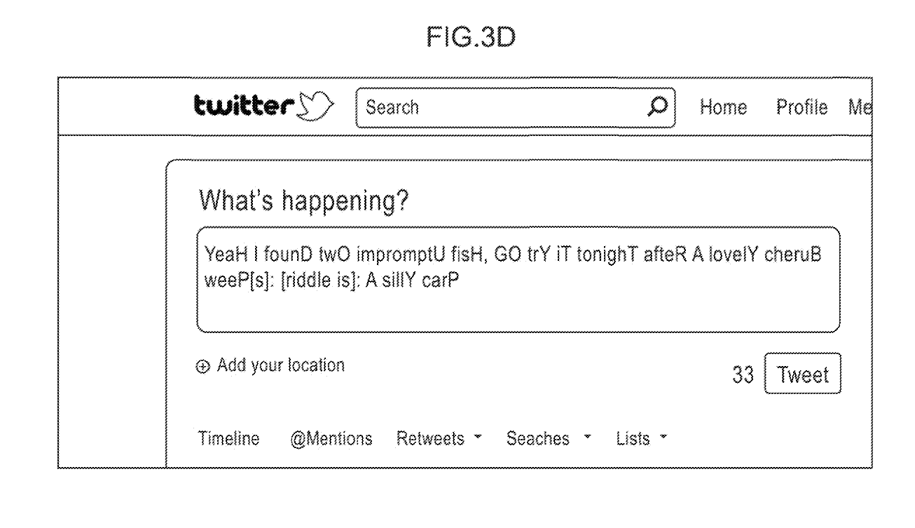

FIGS. 3A-3D show another example of an embodiment of cipher tools and techniques in accordance with various embodiments. In this embodiment, an example of cipher tools and techniques associated with a feed, such as a Twitter feed, are illustrated. This type of embodiment could help a user create a cipher that the user could send via twitter direct message or broadcast out in general to other users who follow them on twitter.

Embodiments could be utilized on a variety of devices including, but not limited to, tablets, e-readers, personal digital assistants, cell phones, personal computers, and/or via websites. Embodiments may include cipher creation tools and/or different cipher solving applications. In general, once a user has the cipher maker application, a user may type in a message they could like to create a cipher for. For example, as shown in FIGS. 3A-3D, a user may want to provide create a cipher for “Happy Birthday to you.” A user may select which type of cipher mechanism the user wants to use. In the examples shown in FIGS. 3A-3D, one example shown utilizes the 1st letter of every word and another example of last letter of every word, though other cipher-based techniques may be utilized. Embodiments may provide several suggested words that meet a specific criteria. The user may reorder words and/or substitute their own word in some cases. Embodiments may provide the user an error message if they substitute a word that will not work or if they go over the number of characters allowed for tweets.

In an example of one embodiment, a user may be prompted to enter what message they would like to encrypt. In some cases, there may be a maximum character limit they may need to stay within. For example, the user may enter a phrase such as “Happy birthday to you”. Embodiments may provide a recommended cipher sentence. For example, the embodiment may provide a sentence such as “I believe people are paying you unusual attention—thought you'd have realized how open our dangerous [riddle is]: terrifying YoYo's.” A user may be given the opportunity to alter the recommended cipher sentence. For example, the user may choose to change “believe” to “bet” and the message is changed to look like this: “I bet people are paying you unusual attention—thought you'd have realized how open our dangerous [riddle is]: terrifying YoYo's,” which is shown in FIG. 3A.

In some embodiments, the cipher sentence may be delivered to a recipient. The recipient may apply different solution filters to the cipher sentence. For example, the recipient may apply a 1st letter of every word solution filter. In this case, the first letter of each word may be capitalized and the message may changes to look like this: “I Bet People Are Paying You Unusual Attention—Thought You'd Have Realized How Open Our Dangerous [riddle is]: Terrifying YoYo's,” as shown in FIG. 3B. A recipient may apply other word solution filters in some embodiments.

In some embodiments, the list of these capitalized letters may appear in a solution workshop area for further manipulation. In some cases, any words in brackets may be omitted from the solution and, in order for the recipient to know this message is a riddle/cipher vs. a “normal” twitter message the string [riddle is] may appear somewhere. In some embodiments, this may be shorten to just [riddle] or [RDL] in order to give the user more characters for their message if the user does not want the phrase riddle is to be considered as a part of the sentence.

For this example, letters shown in solution workshop area would be: IBP AP Y U A T Y H R H O OD T Y. Some embodiments may allow the user/recipient to unscramble the letters to reveal the solution phrase: Happy Birthday to you.

In another example of an embodiment, a cipher sentence may utilize the last letter of every word. Embodiments may provide a recommended cipher sentence such as: “Yeah I found two impromptu fish. Go try it tonight after a lovely cherub weep[s]. [riddle is]: A silly carp,” as shown FIG. 3C. In this embodiment, the last letter of each word may be utilized for a cipher as shown in FIG. 3D, where in this example the last letter has been capitalized: “YeaH I founD twO impromptU fisH. gO TrY iT tonighT afteR A lovelY cheruB weeP[s]. {riddle is]: A sillY carP. In some embodiments, the last letters may be provided to a recipient user. In this example, those letters are: HID OUH O Y T TR A YBP AY P. A recipient user may then solve the cipher by rearranging the letters to reveal the solution phrase: Happy Birthday to you. This example works in a very similar way to the first one however the “s” in weeps is omitted from the list of letters that show up in the solution set denoted by the s being in brackets [s]. Since the S is omitted the letter to be considered last in this word becomes “p”. In general, some embodiments may provide different ciphers that may utilize different tools and techniques that a user may then share with other users using a variety of different user devices.

Some embodiments may provide tools and techniques for displaying annotated content related to a source text in a form that is agnostic to the origins of the source content the user has acquired. For example, a user of the content may enjoy and share annotations despite the fact that one has purchased a book from an epub bookstore and the other has downloaded the book from their library. Similarly, if they both download a pdf file from their study group website and are viewing the file on different types of machines, with different OS's, applications etc. they can still trade annotations about that content without editing the content itself. By providing a mechanism for rating, sorting, and subscribing to annotators, the most useful content will be recognized and thereby encouraged to propagate.

Some embodiments allow a user to interact with the source digital content, such as a book purchased and delivered electronically, or a pdf file sent via email for example, by generating original content of their own. This user generated content may be referred to as annotation and may utilize a variety of data entry methods such as keyboard or stylus. These annotations may be saved as metadata associated with, but separate from, the original digital content. The metadata may be delivered to another device in a separate file from the source, and rendered on another user's device containing a separate copy of the original source content. The annotation metadata file format may be configured such that the location and specific section of the source content is known and the annotation can be rendered in conjunction with the source content.

In some embodiments, annotations may be displayed or hidden by the end user. Annotations may be searched and sorted based on words, phrases etc within the source they are associated with, or as standalone content. Annotations can contain a unique identifier for each annotator, the time, and/or date the annotation was created, and/or a value associated with each annotation that represents it's rating/rank, and information about the source it is related to (i.e. title/author). When an annotation is created in some embodiments, a rating of the annotation may be set to the rating midpoint as the default (i.e. if rating scale is 0-10, the annotations default rating could be 5, for example.)

The source content may not be modified in any structural manner in some embodiments. For example, there may be no adding or deleting of words or phrases, but portions of the source content may be highlighted in some way to distinguish it from the surrounding context. In some cases, there may be a size limit for each annotation.

Multiple annotations may be displayed that are associated with the same selection of the source content. In this case, annotations may be displayed in such a way that the user may review the annotations individually or bring each annotation to the forefront in turn from a stacked list. Users may select to hide or display annotations based an annotations attributes (name, date, ranking, for example). Several user interface methods for interacting with the annotations may be possible and such interactions may be separate from manipulation of the source text. For example, a user may choose to page through annotations with or without the source content visible.

Some embodiments may facilitate user interactions with annotations they did not create including next, previous, bring forward, send back, hide permanently, change rating, merely by way of example. Embodiments may facilitate user interactions with annotations they did create include spell check, publish, edit, save, and/or delete, for example.

Some embodiments may allow a user to hide all annotations, a selection of annotations, and/or a single annotation. Users may choose to display annotations by a specific category and/or criteria. For example, this may include, but is not limited to only annotations they have created, only those created by a member of a group that they have belong to, only annotations with a rating higher than a specific value, and/or only new annotations since a specific date or time. Users may search for and/or be presented with the annotators who have added annotations to the source they are reading. Users may then choose to follow a select number of annotators for any given source content. In some embodiments, users may select annotators and annotations to display while reading the source content and connected to the internet (wired, wireless, for example) or by accessing a website dedicated to the purpose of discovering annotations for a given source or by overall rank.

Some embodiments may allow for the management of annotation delivery, display, /or and categorization (i.e. groups) that may be done within a user's device or via a personalized area of the annotation website, for example. Annotations may be filtered in some embodiments. For example, annotations containing offensive language may be suppressed based on user preference. Annotations may be displayed in a graphical way that is different from the source content. For example, annotations may have a different font, color, and/or border for example. Annotations may include, but are not limited to, text, video, audio, original drawings, symbols, and/or pictures.

In some embodiments, source content that has one or more annotations associated with it may be tagged with some sort of icon or other visual indicator to notify the user the source has been annotated prior to opening this content. For example, an annotation icon may be displayed next to book image or title in a list. Users may query or be presented with information about other books, content, sources that a particular annotator has annotated. For example, if a user enjoy an annotator's comments about one book, the user may be able search for other books this annotator has read and annotated/

System, methods, and/or devices are provided for tracking, rating, and/or filtering annotations associated with source content that can be accessed by users regardless of their hardware and/or software reading devices or applications. Embodiments may allow groups to be formed and managed by the end user compared to the content owner, seller, and/or distributor. Embodiments may provide mechanism for managing, filtering, and/or viewing annotations, which may be created by other users, along with the source content instead of separate from it.

Embodiments may provide tools and techniques for users to enjoy interactions with annotations and annotators without having to manually enter in data about the source content. Some embodiments may provide real time, local access to new annotations published or facilitates offline mode where annotations can be cached, read, rated, and/or created and stored for publishing at a later time.

Some embodiments provide standard format for sharing annotations between disparate content source formats, applications, and hardware devices. Some embodiments may include a mechanism for rating these annotations that can be shared and controlled by end users. A system for aggregating the annotations and ratings may be provided. In some cases, a system for managing users and groups of annotators and/or ratings, which may be local and/or on a website, may be provided.

Embodiment may provide a user interface that allows different functionality with respect to annotations. For example, annotations may be displayed or hidden. A user may subscribe and unsubscribe to annotations. Annotations may be edited, spell checked, and/or published. In some cases, annotation may be cached for offline use. Annotations may be connected visually to the source content without allowing structural changes to the source content in some embodiments. Some embodiments may provide for annotations connected visually to the source content and allowing structural changes to the source content in some modes. For example, some embodiments may allow a user to rewrite the ending to as book as a part of a contents the original author/publisher produces to encourage people to interact with a book.

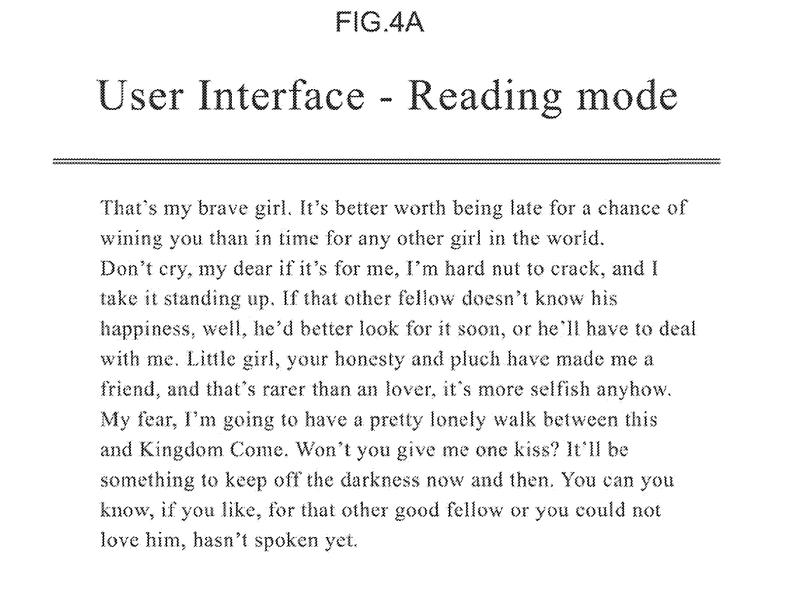

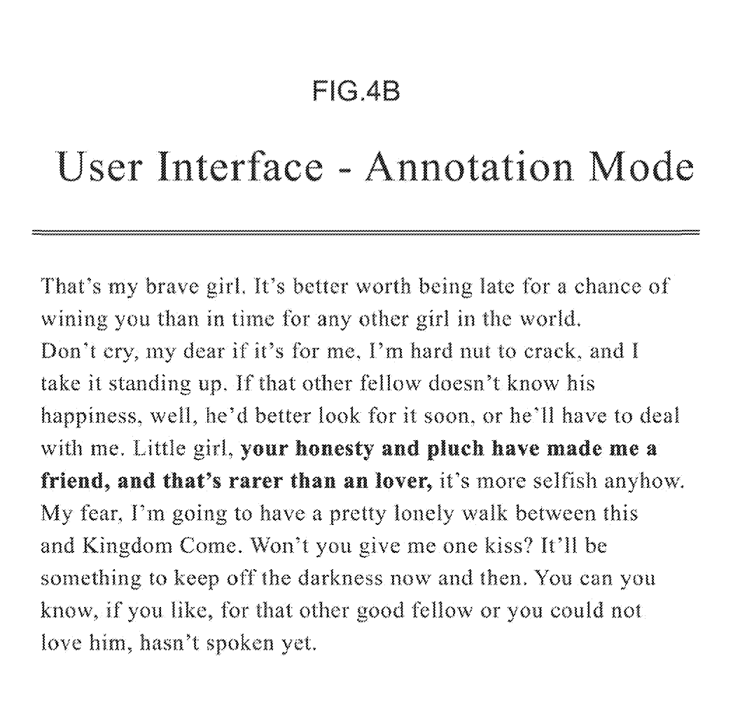

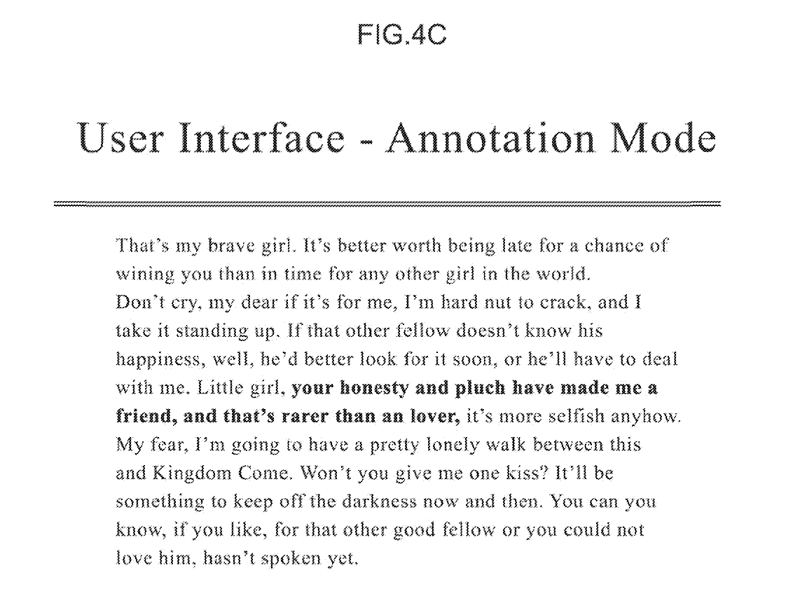

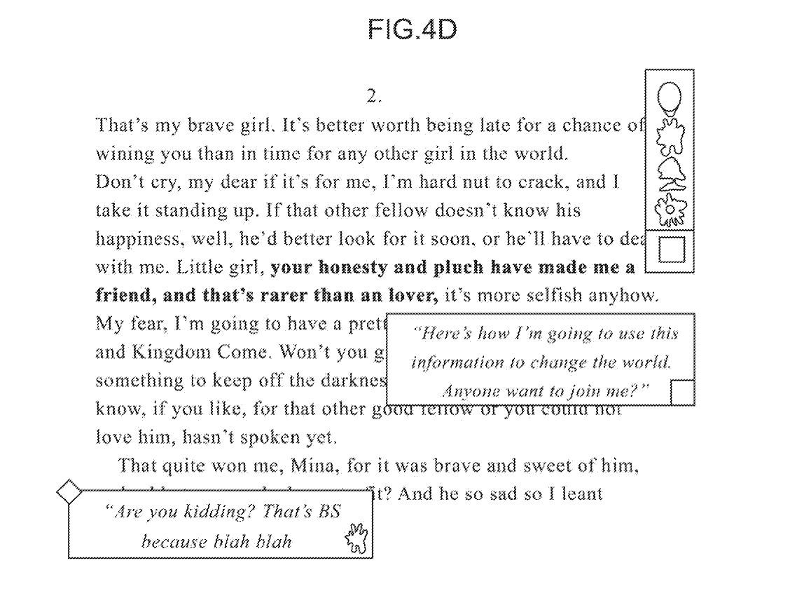

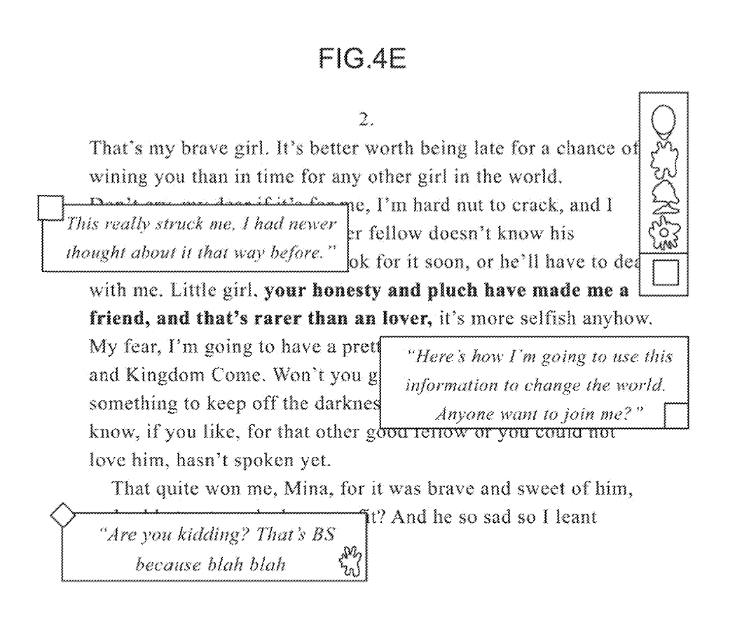

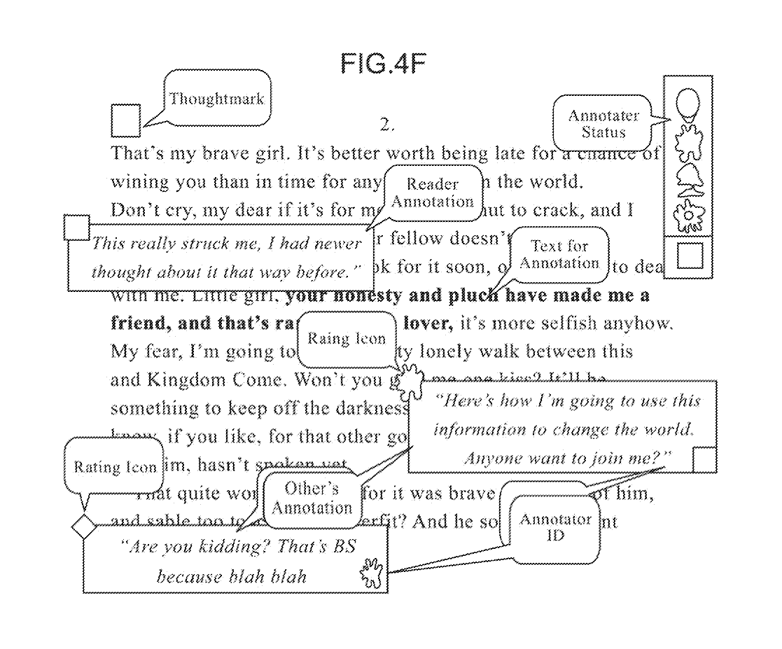

FIGS. 4A-4F show several examples of screen shots that reflect different annotations tools and techniques in accordance with various embodiments. Embodiments may include text that is annotated being distinguished with an icon of the user who annotated it. Embodiments may also contain illustrated thought marks that allow a user to put a placeholder near text they want to annotate later. Some embodiments may also allow a user to rate the annotations of another. FIG. 4A illustrates a screen shot of a user annotation interface in reading mode in accordance with various embodiments. FIG. 4B illustrates a screen shot of a user annotation interface in annotation mode in accordance with various embodiments. FIG. 4C illustrates a screen shot showing user icons of people who have annotated this text (the text is highlighted in bold font). These icons can be displayed or hidden and represent people that the user has elected to follow. FIG. 4D illustrates a screen shot providing the actual annotations that people may have added (their icons appear in bottom right corner of annotation block. Also the thoughtmark icon is visible (looks like a sticky note). FIG. 4E illustrates a screen shot showing text added to the thoughtmark. FIG. 4F illustrates a screen shot showing numerous elements of these features called out on a single page.

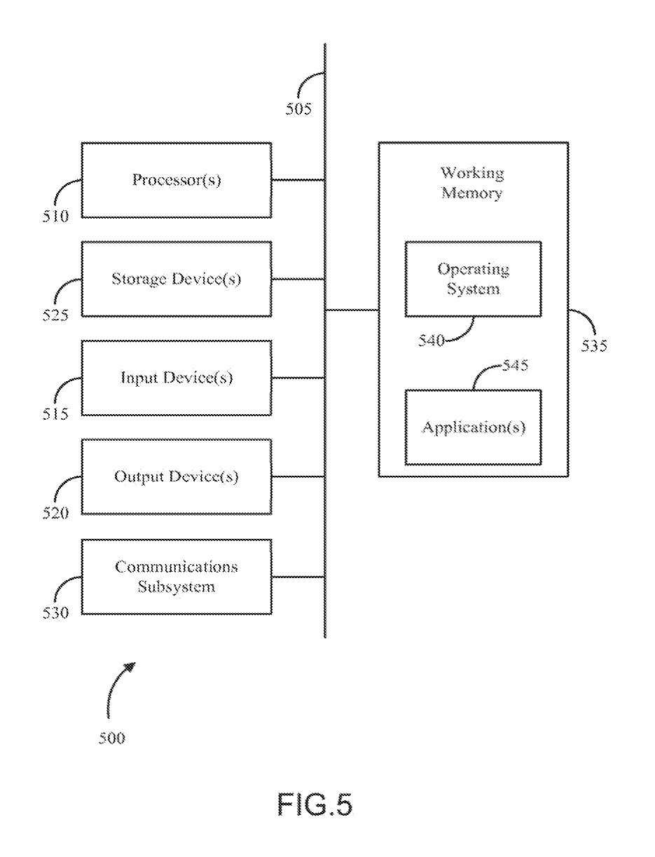

FIG. 5 provides a schematic illustration of one embodiment of a device or system 500 that can perform the methods provided by various other embodiments, as described herein, and/or can function as to provide different cipher and/or annotation tools and techniques. Device 500 may exemplify different devices including, but not limited to, a mobile device, an e-reader, a tablet, a cell phone, and/or a computer. It should be noted that FIG. 5 is meant only to provide a generalized illustration of various components, any or all of which may be utilized as appropriate. FIG. 5, therefore, broadly illustrates how individual device elements may be implemented in a relatively separated or relatively more integrated manner.

Device 500 is shown comprising hardware elements that can be electrically coupled via a bus 505 (or may otherwise be in communication, as appropriate). The hardware elements may include one or more processors 510, including without limitation one or more general-purpose processors and/or one or more special-purpose processors (such as digital signal processing chips, graphics acceleration processors, and/or the like); one or more input devices 515, which can include without limitation a mouse, a keyboard and/or the like; and one or more output devices 520, which can include without limitation a display device, a printer and/or the like.

Device 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

Device 500 might also include a communications subsystem 530, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like.

The communications subsystem 530 may permit data to be exchanged with a network (such as the network described below, to name one example), other computer systems, and/or any other devices described herein. In many embodiments, device 500 will further comprise a working memory 535, which can include a RAM or ROM device, as described above.

Device 500 also can comprise software elements, shown as being currently located within the working memory 535, including an operating system 540, device drivers, executable libraries, and/or other code, such as one or more application programs 545, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer readable storage medium, such as the storage device(s) 525 described above. In some cases, the storage medium might be incorporated within a computer system, such as device 500. In other embodiments, the storage medium might be separate from a computer system (i.e., a removable medium, such as a compact disc, etc.), and or provided in an installation package, such that the storage medium can be used to program, configure and/or adapt a general purpose computer with the instructions/code stored thereon. These instructions might take the form of executable code, which is executable by device 500 and/or might take the form of source and/or installable code, which, upon compilation and/or installation on device 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as device 500) to perform methods in accordance with various embodiments of the invention. According to a set of embodiments, some or all of the procedures of such methods are performed by device 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operation in a specific fashion. In an embodiment implemented using device 500, various computer readable media might be involved in providing instructions/code to processor(s) 510 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical and/or magnetic disks, such as the storage device(s) 525. Volatile media includes, without limitation, dynamic memory, such as the working memory 535. Transmission media includes, without limitation, coaxial cables, copper wire and fiber optics, including the wires that comprise the bus 505, as well as the various components of the communication subsystem 530 (and/or the media by which the communications subsystem 530 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by device 500. These signals, which might be in the form of electromagnetic signals, acoustic signals, optical signals and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc.

carried by the signals) to the working memory 535, from which the processor(s) 505 retrieves and executes the instructions. The instructions received by the working memory 535 may optionally be stored on a storage device 525 either before or after execution by the processor(s) 510.

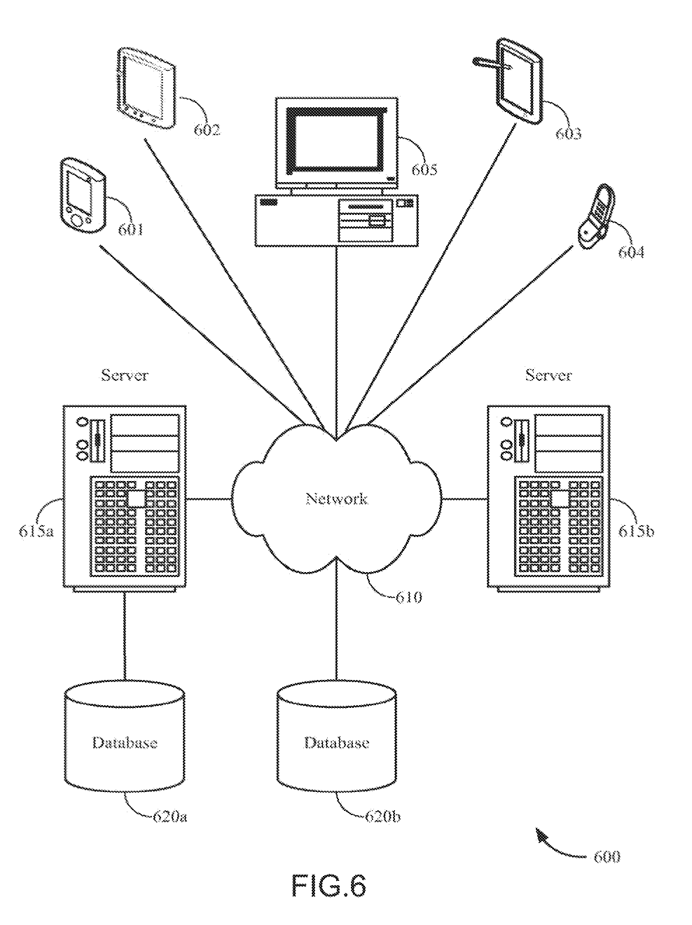

Some embodiments may implemented utilizing a system such as system 600 of FIG. 6. FIG. 6 illustrates a schematic diagram of a system 600 that can be used in accordance with one set of embodiments. System 600 can include different devices including, but not limited to, one or more user personal digital assistants 601, e-readers 602, tablets 603, cell phones 604, and/or computers 605. Devices 601, 602, 603, 604, and/or 605 an also have any of a variety of applications, including one or more applications configured to perform methods provided by various embodiments (as described above, for example), as well as one or more office applications, database client and/or server applications, and/or web browser applications. Devices 601, 602, 603, 604, and/or 605 may be capable of communicating via a network (e.g., the network 610 described below) and/or displaying and navigating web pages or other types of electronic documents. Although the exemplary system 600 is shown with five user devices, any number of user devices can be supported.

Certain embodiments of the invention operate in a networked environment, which can include a network 610. The network 610 can be any type of network familiar to those skilled in the art that can support data communications using any of a variety of commercially-available (and/or free or proprietary) protocols, including without limitation TCP/IP, SNA, IPX, AppleTalk, and the like. Merely by way of example, the network 610 can be a local area network (“LAN”), including without limitation an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 615. Each of the server computers 615 may be configured with an operating system, including without limitation any of those discussed above, as well as any commercially (or freely) available server operating systems. Each of the servers 615 may also be running one or more applications, which can be configured to provide services to one or more user devices 601, 602, 603, 604, and/or 605 and/or other servers 615.

Merely by way of example, one of the servers 615 may be a web server, which can be used, merely by way of example, to process requests for web pages or other electronic documents from user devices 601, 602, 603, 604, and/or 605. The web server can also run a variety of server applications, including HTTP servers, FTP servers, CGI servers, database servers, Java servers, and the like. In some embodiments of the invention, the web server may be configured to serve web pages that can be operated within a web browser on one or more of user devices 601, 602, 603, 604, and/or 605 to perform methods of the invention.

The server computers 615, in some embodiments, might include one or more application servers, which can be configured with one or more applications accessible by a client running on one or more of user devices 601, 602, 603, 604, and/or 605 and/or other servers 615. Merely by way of example, the server(s) 615 can be one or more general purpose computers capable of executing programs or scripts in response to user devices 601, 602, 603, 604, and/or 6055 and/or other servers 615, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including without limitation those commercially available from Oracle, Microsoft, Sybase™, IBM™, Apple, and the like, which can process requests from clients (including, depending on the configuration, dedicated database clients, API clients, web browsers, etc.) running on a user devices 601, 602, 603, 604, and/or 605 and/or another server 615. In some embodiments, an application server can create web pages dynamically for displaying the information in accordance with various embodiments. Data provided by an application server may be formatted as one or more web pages (comprising HTML, Javascript, etc., for example) and/or may be forwarded to user devices 601, 602, 603, 604, and/or 605 via a web server (as described above, for example). Similarly, a web server might receive web page requests and/or input data from user devices 601, 602, 603, 604, and/or 605 and/or forward the web page requests and/or input data to an application server. In some cases a web server may be integrated with an application server.

In accordance with further embodiments, one or more servers 615 can function as a file server and/or can include one or more of the files (e.g., application code, data files, etc.) necessary to implement various disclosed methods, incorporated by an application running on a user devices 601, 602, 603, 604, and/or 605 and/or another server 615. Alternatively, as those skilled in the art will appreciate, a file server can include all necessary files, allowing such an application to be invoked remotely by a user devices 601, 602, 603, 604, and/or 605 and/or server 615.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620. The location of the database(s) 620 is discretionary: merely by way of example, a database 620a might reside on a storage medium local to (and/or resident in) a server 615a (and/or a user device 601, 602, 603, 604, and/or 605). Alternatively, a database 620b can be remote from any or all of the user devices 601, 602, 603, 604, and/or 605, 615, so long as it can be in communication (e.g., via the network 610) with one or more of these. In a particular set of embodiments, a database 620 can reside in a storage-area network (“SAN”) familiar to those skilled in the art. Likewise, any necessary files for performing the functions attributed to the user devices 601, 602, 603, 604, and/or 605 can be stored locally on the respective computer and/or remotely, as appropriate. In one set of embodiments, the database 635 can be a relational database, such as an Oracle database, that is adapted to store, update, and retrieve data in response to SQL-formatted commands. The database might be controlled and/or maintained by a database server, as described above, for example.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while various functions are ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims

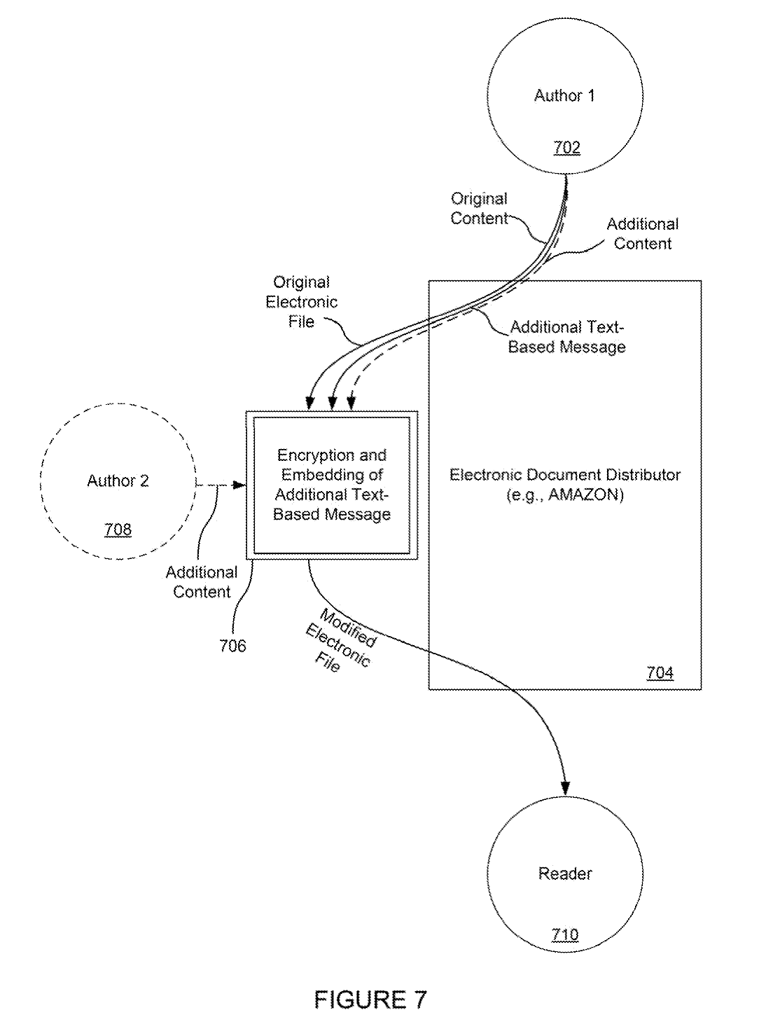

FIG. 7 illustrates a flow chart for generating and delivering an electronic file. A first author 702 can generate original content, such as an e-book, webpage content, text message, WORD or PDF document, POWERPOINT presentation, APPLE PAGES, IMESSAGE etc. The original content can include a first text-based message (e.g., text of a text message or the story of an e-book, to name two examples). The original content can be provided to an electronic document distributor 704 such as an e-book publisher (e.g., AMAZON). The electronic document distributor 704 can put the original content into a format for distribution, called an original electronic file. Such a distributor 704 may be an e-book publisher, or may be an intermediary for messaging services such as a cell phone carrier. Alternatively, the distributor 704 can be a program such as MICROSOFT WORD or ADOBE ACROBAT, which take the original content (e.g., text) and produce an original electronic file in the form of a WORD or PDF document. The first author can also provide an additional text-based message (e.g., “happy birthday”) to the electronic document distribution 704.

The original electronic file and the additional text-based message can be provided to an encryption module 706. The encryption module 706 can be part of a computing device (not illustrated) and can operate on a processor (e.g., application processor) of the device and access and write to a memory of the computing device. The original electronic file and the additional text-based message can be stored in the memory of the computing device.

The encryption module 706 can be configured to embed the additional text-based message in the original electronic file via encryption using one of a plurality of ciphers. In one embodiment, the original electronic file includes a first text-based message, so the additional text-based message (or second text-based message) can be encrypted within the first text-based message. This encryption process generates a first proposed modification to the electronic file. In some cases, the first proposed modification can be returned to the electronic document distributor 704 and distributed to one or more readers 710. However, in many embodiments, the first proposed modification to the electronic file can be analyzed for approval of the modification. This approval can be automated within the encryption module (e.g., automatic checking for grammar and logic) or can be received from a user. In one embodiment, the encryption module 706 prompts a first user for approval of the first proposed modification to the electronic file.

Whatever entity performs the analysis, if approval is received, then the first proposed modification can be used (or converted into) a modified electronic file. The modified electronic file can then be passed back to the electronic document distributor 704 and then distributed to a plurality of readers 710. While the illustration shows the modified electronic file passing back to the electronic document distributor 704 and then on to the reader 710, in some cases the modified electronic file can be passed directly to the reader 710.

If approval is not received, or is denied, then the encryption module 706 can generate a second proposed modification to the electronic file. The second proposed modification can either include using the originally-selected cipher in a new fashion to decrypt the additional text-based message, or a different cipher can be used. For instance, if the first proposed modification used a cipher where the message is encrypted via first letters of each word, then the second cipher may encrypt the additional text-based message in the last letter of each word. In another embodiment, a second proposed modification to the electronic file can be provided by a user, or the user can make his/her own changes to the second proposed modification as generated by the encryption module 706. In one embodiment, the user can be the second author 708. In another embodiment, the user can be an agent of the electronic document distributor 704.

Optionally, the first author 702 or a second author 708 can provide additional content, such as a bonus chapter to an e-book, background information on a key character in a story, or a link to coupons, to name three non-limiting examples. The encryption module 706 can embed the additional content in the original electronic file and create one or more links to the additional content that may or may not be locked. If locked, then the additional content can be referred to as locked additional content. Therefore, the reader 710 may access the additional content, if unlocked, by selecting the corresponding link(s). For locked content, the reader 710 may be required to decrypt the encrypted additional text-based message in order to access the additional content. For instance, the encrypted message, once decrypted, may provide access to a link or may enable an already-accessible link. Alternatively, decrypting the encrypted message may provide access to, or a clue to, a second encrypted message, which once decrypted provides access to the additional content.

In some embodiments, an ability to decrypt the encrypted message may only be available once the reader 710 reaches a certain point in the modified electronic file (e.g., page 90 of 360). Along these same lines, the ability to decrypt the encrypted message may only be available once the reader 710 touches a touch screen display that is rendering a predefined page or portion of a page of the modified electronic file.

In some embodiments, the modified electronic file can be an SMS, text message, IMESSAGE or other messaging file delivered to a cellular phone, smartphone, or tablet computer of the reader 710. The modified electronic file can, in some instances, be rendered in a web browser, for instance as a webpage or a portion of a webpage. Such a webpage may include a social media webpage such as FACEBOOK or TWITTER. For instance, the modified electronic file may be used to generate a FACEBOOK ‘update’ or wall posting. In another instance, the modified electronic file can be used to generate a TWITTER TWEET.

In some embodiments, the additional content can be a second text-based message that is further encrypted within the original electronic file. In one embodiment, the encryption module 706 can embed a tag in the modified electronic file indicating what cipher was used to encrypt the additional text-based message.

In some embodiments, the encryption module 706 can operate on a server remote from the author 702 and can be accessed via a network such as the Internet. In other embodiments, the encryption module 706 can reside as a standalone application within a computing device operated by the author 702.

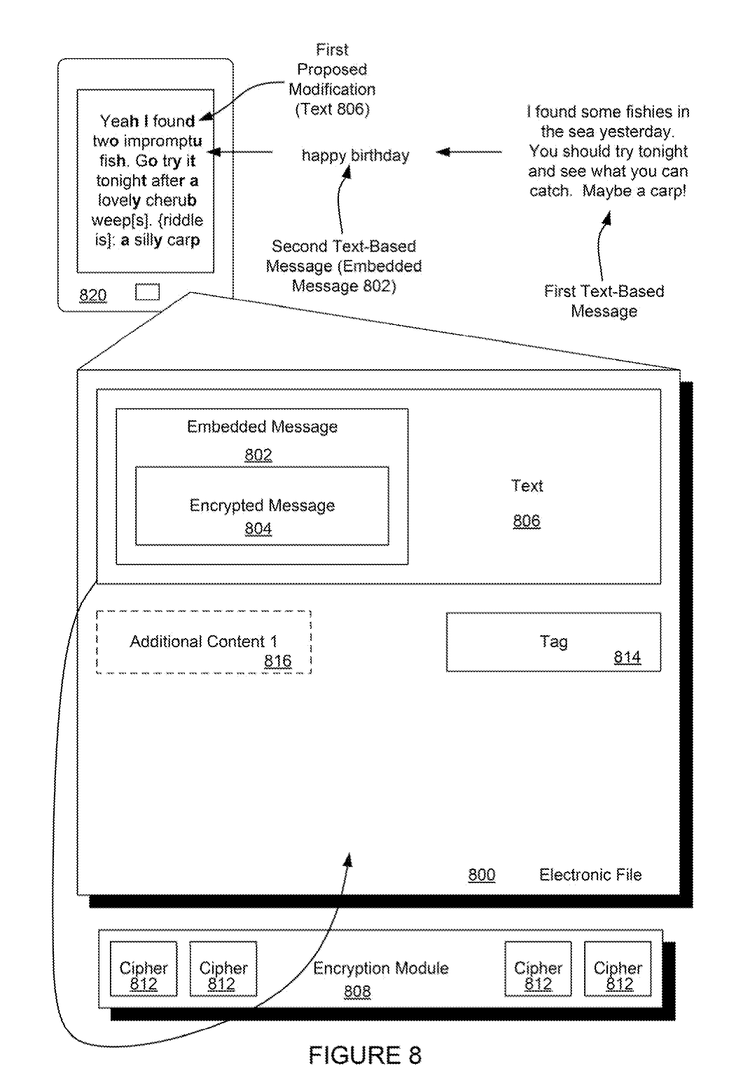

FIG. 8 illustrates a block diagram of a system configured to encrypt a message in an electronic file. The electronic file 800 can reside in a memory of a computing device 820 (e.g., a tablet computer, notebook computer, ultrabook, or smartphone to name a few), such as an e-book reader (e.g., NOOK, KINDLE TOUCH, to name two). Initially, a first text-based message can be provided such as “I found some fishies in the sea yesterday. You should try tonight and see what you can catch. Maybe a carp!” This message could be part of an e-book, a webpage, a WORD or PDF document, a POWERPOINT presentation, an image caption, a text or SMS message, or any other electronic file 800. A second text-based message can also be provided that is to be encrypted and embedded in the first text-based message. This second text-based message can also be referred to as an embedded message 802 and is intended for encryption. In the illustrated embodiment, the second text-based message, or embedded message 802, is “happy birthday.” An encryption module 808 that runs on the computing device 820 can take the embedded message 802 (the second text-based message) and encrypt it within the first text-based message to generate a first proposed modification to the electronic file 800. This can be done using one of a plurality of ciphers 812. The first proposed modification if rendered on a display of the computing device 820 may appear as the illustrated text 806 in FIG. 8, where the bold letters represent an encrypted message 804 form of the embedded message 802.

The first proposed modification can be presented for approval, for instance to a user. Alternatively, automated checks can be performed to determine if the first proposed modification meets certain criteria such as grammatical and logical correctness. If approved, the first proposed modification to the electronic file can be carried out by the encryption module 808. In one embodiment, the encryption module 808 can also generate a tag 814 indicative of the one of the plurality of ciphers 812 used to generate the encrypted message 804.

Once the encryption is completed, the electronic file 800 has been transformed into a modified electronic file that can be passed to a second user such as an e-book reader or a text message recipient.

Although the encryption module 808 is illustrated as being separate from the electronic file 800, in some embodiments, the encryption module 808 can reside within the electronic file 800.

Optionally, additional content 816 can be part of the electronic file. The additional content 816 can be accessed after a user decrypts the encrypted message. The additional content 816 can include additional chapters of a story or background information related to a location in a story, to name two non-limiting examples.

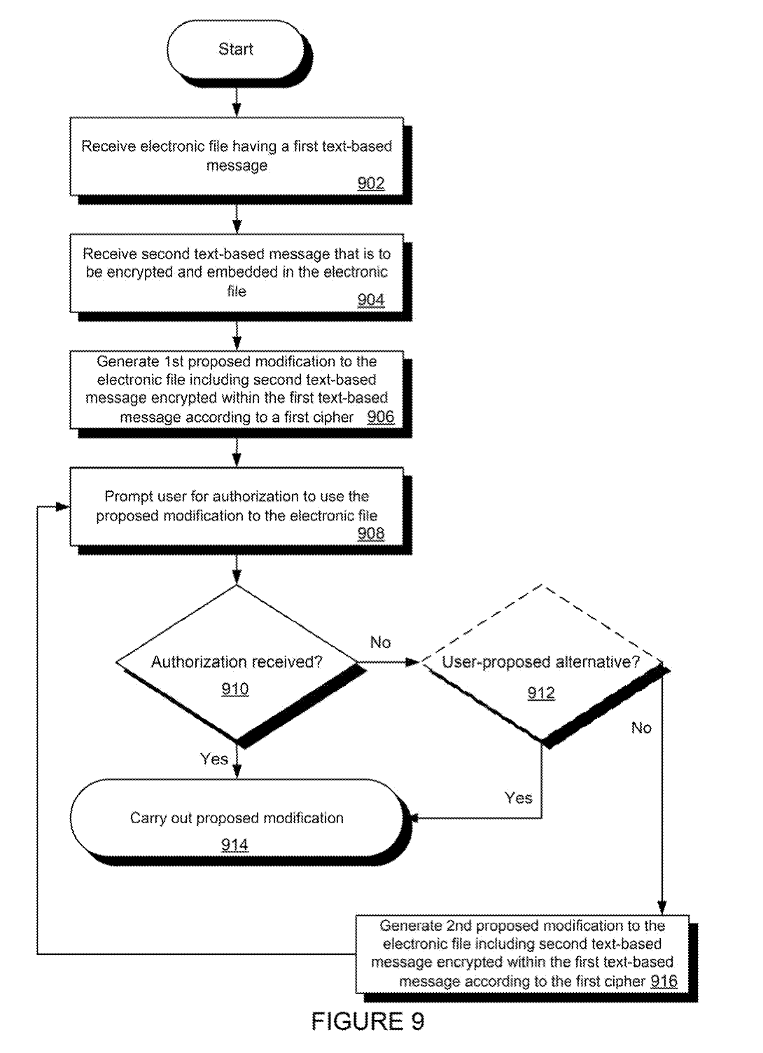

FIG. 9 illustrates a method for encrypting a message within an electronic file. The method 900 begins with the receipt of an electronic file having a first text-based message in a receive operation 902. A second receive operation 904 then receives a second text-based message that is to be encrypted and embedded in the electronic file. The method 900 then generates a first proposed modification to the electronic file including the second text-based message being encrypted within the first text-based message according to a first cipher. This occurs in a generate operation 906. The method 900 then prompts a user for authorization to use the first proposed modification to the electronic file in a prompt operation 908. The prompt operation 908 can also be automated. An authorization received decision 910 then determines whether authorization of the first proposed modification exists or is received and if so, the first proposed modification is carried out in carry out operation 914. If authorization does not exist or a denial is received, then an optional user-proposed alternative decision 912 determines whether a user is providing its own alternative proposed modification. If so, then the method 900 carries out the alternative modification as proposed by the user in the carry out operation 914. If a user-proposed alternative does not exist or where the user-proposed alternative decision does not exist, the method 900 generates a second proposed modification to the electronic file including the second text-based message encrypted within the first text-based message in a generate second proposed modification operation 916. The second proposed modification can be generated according to the first cipher. However, in other embodiments, a second cipher can be used. A user or automated decision is then prompted again via the prompt operation 908 and the method 900 carries on as described above until an acceptable proposed modification is found.

FIG. 10 illustrates a block diagram of a system configured to decrypt a message in an electronic file. An electronic file 1000 is provided to a computing device 1020 such as an e-book reader, smartphone, or tablet computer to name a few non-limiting examples. The electronic file 1000 includes text 1006 such as “Yeah I found two impromptu fish. Go try it tonight after a lovely cherub weep[s]. {riddle is]: a silly carp” where a last letter of each word is highlighted. This highlighting can be provided by functionality of a decryption assist module 1009 or 1008 residing either as part of the electronic file 1000 or apart from the electronic file 1000. In some embodiments, the decryption assist module 1008 can even be a web-based application that runs remotely on a server system and remotely provided decryption functionality to the computing device 1020. The decryption assist module 1009 or 1008 can highlight letters in the text 1006 that are to be used in decrypting an encrypted message 1004, although other forms of decryption assistance can also be provided. The decryption assist module 1009 or 1008 can partially decrypt the encrypted message 1004 by recognizing which one of a plurality of ciphers 1013 or 1012 were used to encrypt the encrypted message 1004 as indicated by a tag 1014 that is part of the electronic file 1000. The decryption assist module 1009 or 1008 can then use the identified one of the plurality of ciphers 1013 or 1012 to partially decrypt the encrypted message 1004. A user can then work with this partial decryption (e.g., “hidouhoyttraybayp”) to decrypt the rest of the message thus arriving at the embedded message 1002 (e.g., “happy birthday”). The user can complete the decryption via one or more touches to a touch screen display of the computing device 1020.

The decryption assist modules 1008, 1009 can provide a variety of assistance methods to help decrypt an encrypted message. Some examples have already been discussed, as for instance the clues in FIGS. 1F, 1J, and 1U, the overlay in FIG. 1R, or the clue in FIG. 2H. Additionally, the decryption assist module 1008, 1009 can be configured to identify when the encrypted message has been decrypted and take further action such as presenting an additional message (see for example FIG. 2k) or linking to additional content 1016, 1018.

In some embodiments, the ciphers 1013 or 1012 can be separately stored from the decryption assist module 1009 or 1008. In some instances, the decryption assist module 1008 can be downloaded to the computing device 1020 along with the electronic file 1000. In other instances, the decryption assist module 1008 can be separately downloaded to the computing device 1020, for instance where the decryption assist module 1008 is downloaded at a first time and multiple electronic files 1000 can be downloaded and partially decrypted at subsequent times.

In some embodiments, optional additional content 1016 or 1018 can be downloaded to the computing device 1020 and can be accessed when the embedded message 1002 is decrypted by the user. In some cases the user can use the embedded message 1002 to access the additional content 1016, 1018, while in other cases the act of decrypting the embedded message 1002 may trigger a link to additional content 1016, 1018. In some embodiments, the additional content 1016, 1018 may not be available until a user has accessed certain points in the electronic file 1000 (e.g., read through Chapter 22 or turned to a fifteenth slide of a POWERPOINT presentation). In one embodiment, the user cannot access the additional content 1016, 1018 until he/she utilizes a link such as a URL provided via e-mail or some other method of delivery (e.g., writing in a magazine or the pages of a book). In some instances, the additional content 1018 can reside on a remote server and only be downloaded to the computing device 1020 when the user decrypts the embedded message 1002.

The additional content 1016, 1018 can be updated or modified remotely even while residing on the computing device 1020. For instance, an author may rewrite a bonus chapter of an e-book and remotely push the updated chapter to all computing devices having the bonus chapter.

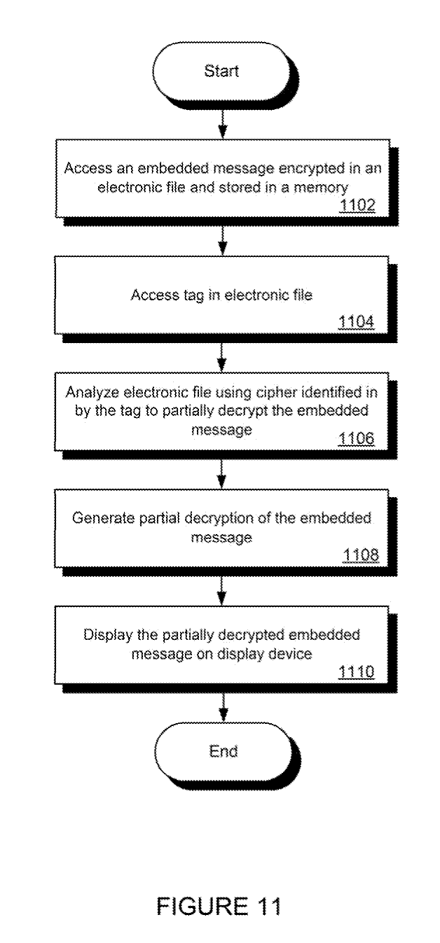

FIG. 11 illustrates a flow chart of a method for decrypting an encrypted message.

The method can access an embedded message encrypted in an electronic file and stored in a memory of a computing device (e.g., 1020) in a first access operation 1102. The method can also access a tag of the electronic file via a second access operation 1104. The second access operation 1104 can be carried out by a decryption assist module (e.g., 1016, 1018). The tag can identify one of a plurality of ciphers used to encrypt the embedded message. Using the tag, the decryption assist module can analyze the electronic file using a cipher identified by the tag to partially decrypt the embedded message in an analyze operation 1106. In a generate operation 1108, the decryption assist module generates a partial decryption of the embedded message based on the results of the analyze operation 1106. Via a display operation 1110, the partially decrypted embedded message can be displayed so that a user can try to fully decrypt the embedded message.

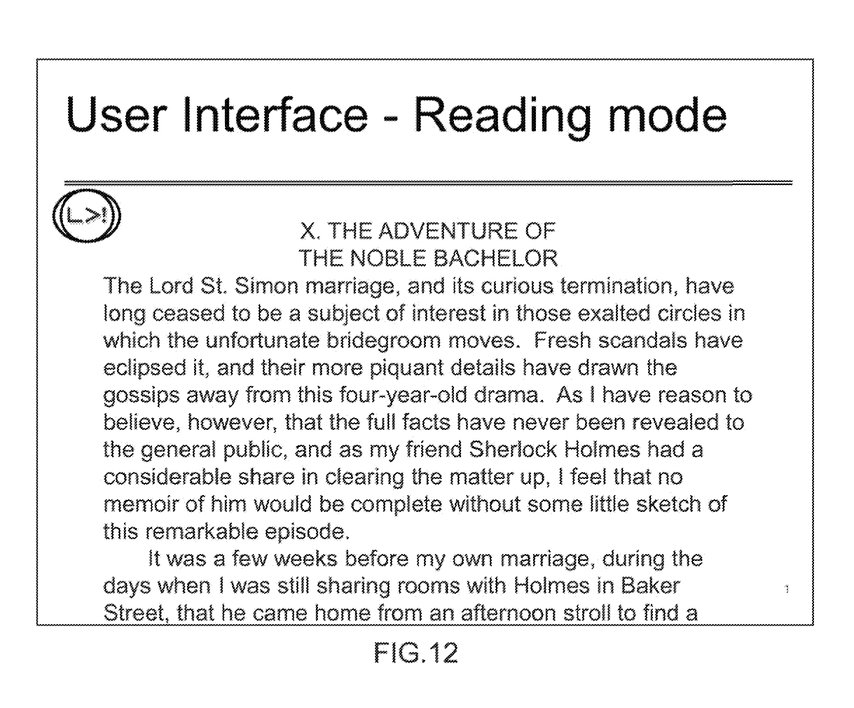

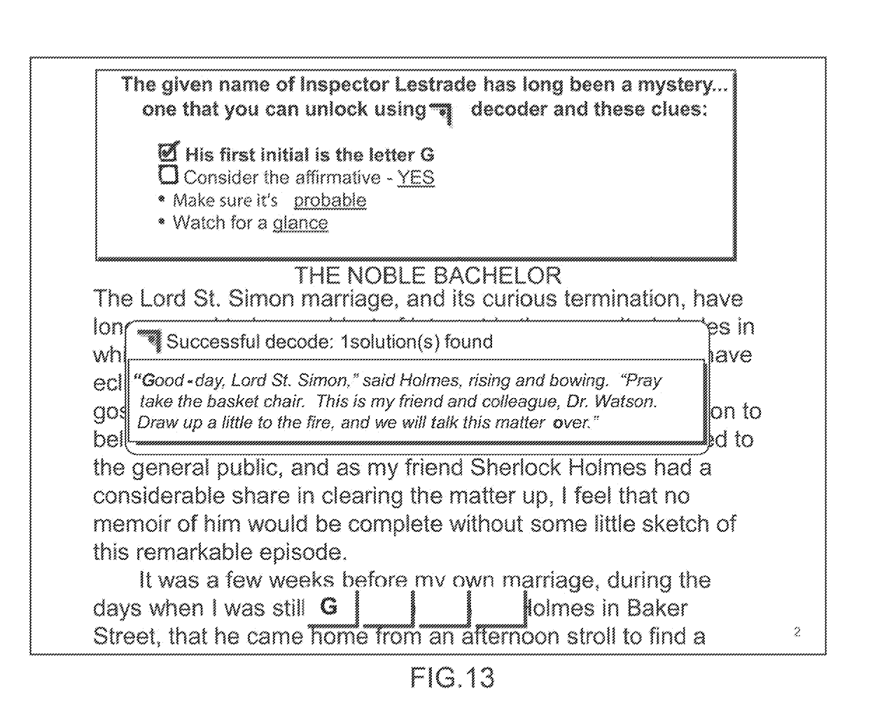

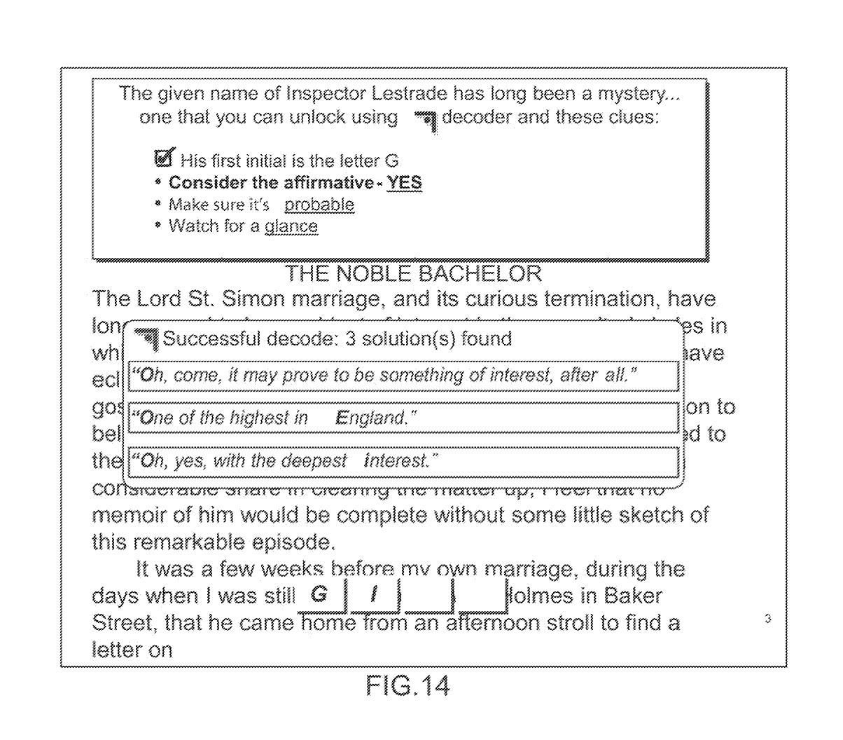

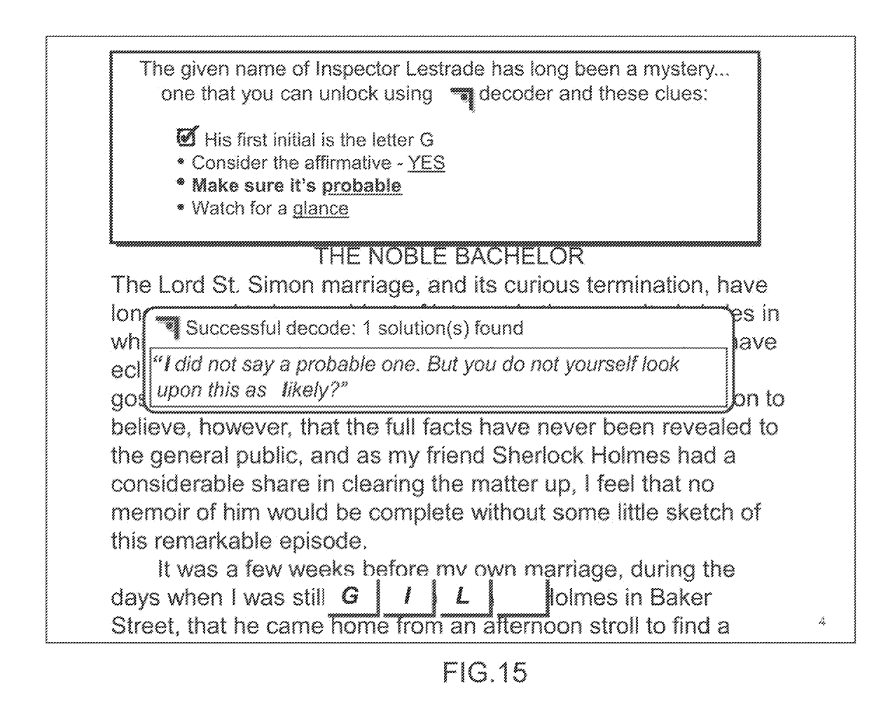

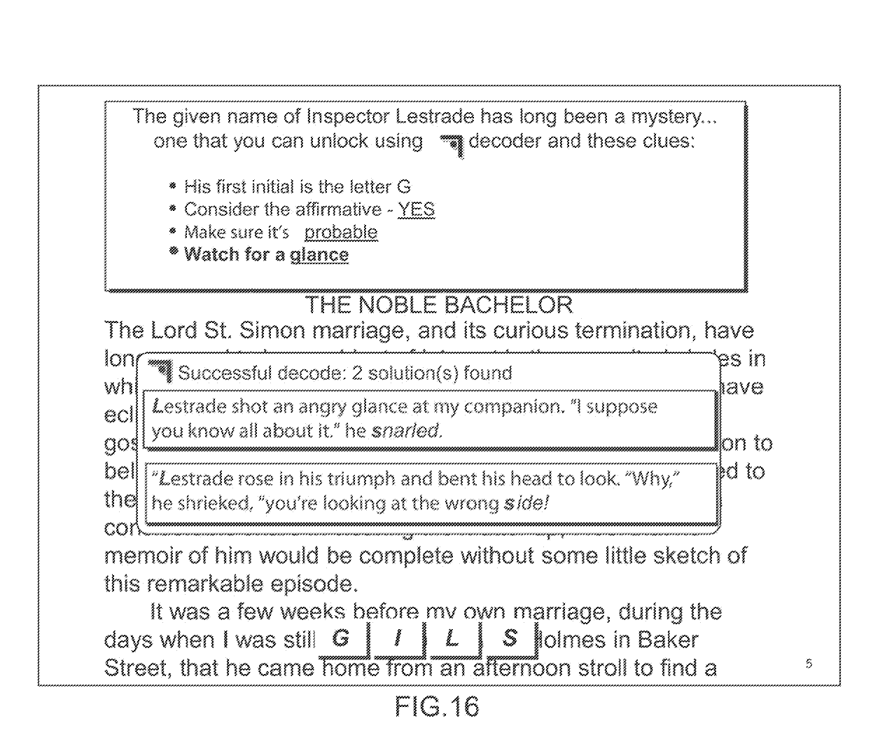

FIGS. 12-16 illustrate exemplary user interfaces demonstrating an electronic file being partially and then fully decrypted by a user with the help of a decryption assist module.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while various functionalities are ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method for generating an electronic file having an encrypted message therein, the method comprising:
receiving an electronic file into a memory, the electronic file having a first text-based message;
receiving a second text-based message into the memory that is to be encrypted within the first text-based message; and
generating, via an encryption module, a first proposed modification to the electronic file, wherein the first proposed modification encrypts the second text-based message in the first text-based message according to a first cipher selected from a plurality of ciphers.

2. The method of claim 1, further comprising:
prompting a first user for approval of the first proposed modification to the electronic file; and
if approval is received, then generating a modified electronic file using the first proposed modification including encrypting the second text-based message within the first text-based message according to the first cipher.

3. The method of claim 1, wherein the modified electronic file is provided to an e-book publisher who then distributes the modified electronic file to one or more readers.

4. The method of claim 1, wherein the modified electronic file is provided to a second user as an SMS message.

5. The method of claim 1, wherein the modified electronic file is rendered in a web browser.

6. The method of claim 5, wherein the modified electronic file is rendered on a social media webpage.

7. The method of claim 1, further comprising embedding a link in the electronic file, such that the link provides a second user access to additional content upon decrypting the second text-based message.

8. The method of claim 7, wherein the additional content is another encrypted message.

9. The method of claim 1, further comprising adding a tag to the electronic file identifying the cipher used.

10. A non-transitory, tangible computer readable storage medium, encoded with processor readable instructions to perform a method for partially decrypting an encrypted message embedded in an electronic file, the method comprising:
accessing an embedded message encrypted in an electronic file and stored in a memory;
accessing a tag in the electronic file, via a decryption assist module, where the tag identifies one of a plurality of ciphers used to encrypt the embedded message;
analyzing, via the decryption assist module, the electronic file using the identified cipher to partially decrypt the embedded message;
generating a partial decryption of the embedded message from the analyzing; and
displaying the partially decrypted embedded message on a display device.

11. The non-transitory, tangible computer readable storage medium of claim 10, wherein the locked additional content is stored in the tangible computer readable storage medium.

12. The non-transitory, tangible computer readable storage medium of claim 10, wherein the locked additional content is stored external to the tangible computer readable storage medium.

13. The non-transitory, tangible computer readable storage medium of claim 10, wherein the locked additional content is configured for use by the decryption assist module to aid in decrypting a second encrypted message.

14. The non-transitory, tangible computer readable storage medium of claim 10, wherein the locked additional content is remotely updated after the user accesses the electronic file.

15. The non-transitory, tangible computer readable storage medium of claim 10, wherein the decryption assist module is part of an application that reads data from the electronic file and renders the data to a display device.

16. The non-transitory, tangible computer readable storage medium of claim 10, wherein the electronic file is an application.

17. The non-transitory, tangible computer readable storage medium of claim 16, wherein the wherein the decryption assist module is part of the electronic file.

18. The non-transitory, tangible computer readable storage medium of claim 10, further comprising displaying a clue on the display device configured to aid in decrypting the embedded message.

19. The non-transitory, tangible computer readable storage medium of claim 10, wherein the identified cipher is a linked-letter cipher.
